(19) United States
(12) Patent Application Publication
(10) Pub. No.: US 2014/0267031 A1
(43) Pub. Date: Sep. 18, 2014

(54) SPATIALLY AWARE POINTER FOR MOBILE APPLIANCES

(71) Applicant: Kenneth J. Huebner, Milwaukee, WI (US)

(72) Inventor: Kenneth J. Huebner, Milwaukee, WI (US)

(21) Appl. No.: 13/796,728

(22) Filed: Mar. 12, 2013

(51) Int. Cl. G06F 3/0346

(52) U.S. Cl. CPC G06F 3/0346
USPC 345/158

(57) ABSTRACT

A spatially aware pointer that can augment a pre-existing mobile appliance with remote control, hand gesture detection, and/or 3D spatial depth sensing abilities. In at least one embodiment, a spatially aware pointer can be operatively connected to the data port of a mobile appliance (e.g., mobile phone or tablet computer) to provide remote control, hand gesture detection, and 3D spatial depth sensing abilities to the mobile appliance. Such an enhancement may, for example, allow a user with a mobile appliance to make a 3D spatial model of at least a portion of an environment, or remotely control a TV set with hand gestures, or engage other mobile appliances to create interactive projected images.

### FIELD OF THE DISCLOSURE

The present disclosure relates to spatially aware pointers that can augment pre-existing mobile appliances with remote control, hand gesture detection, and/or 3D spatial depth sensing abilities.

### BACKGROUND OF THE INVENTION

Currently, there are many types of handheld, device pointers that allow a user to aim and control an appliance such as a television (TV) set, projector, or music player, as examples. Unfortunately, such pointers are often quite limited in their awareness of the environment and, hence, quite limited in their potential use.

For example, a handheld TV controller allows a user to aim and click to control a TV screen. Unfortunately, this type of pointer typically does not provide hand gesture detection and spatial depth sensing of remote surfaces within an environment. Similar deficiencies exist with video game controllers, such as the Wii® controller manufactured by Nintendo, Inc. of Japan. Moreover, some game systems, such as Kinect® from Microsoft Corporation of USA provide 3D spatial depth sensitivity, but such systems are typically used as stationary devices within a room and constrained to view a small region of space.

Yet today, people are becoming ever more mobile in their work and play lifestyles. There are ever growing demands being placed on our mobile appliances such as mobile phones, tablet computers, digital cameras, game controllers, and compact multimedia players. But such appliances often lack remote control, hand gesture detection, and 3D spatial depth sensing abilities.

Moreover, in recent times some mobile appliances, such as cell phones and digital cameras, have built-in image projectors that can project an image onto a remote surface. But these projector-enabled appliances are often forlorn to project images with little user interactivity.

Therefore, there is an opportunity for a spatially aware pointer that can augment pre-existing mobile appliances with remote control, hand gesture detection, and/or 3D spatial depth sensing abilities.

### SUMMARY

The present disclosure relates to apparatuses and methods for spatially aware pointers that can augment pre-existing mobile appliances with remote control, hand gesture detection, and/or 3D spatial depth sensing abilities. Pre-existing mobile appliances may include, for example, mobile phones, tablet computers, video game devices, image projectors, and media players.

In at least one embodiment, a spatially aware pointer can be operatively coupled to the data port of a host appliance, such as a mobile phone, to provide 3D spatial depth sensing. The pointer allows a user to move the mobile phone with the attached pointer about an environment, aiming it, for example, at walls, ceiling, and floor. The pointer collects spatial information about the remote surfaces, and a 3D spatial model is constructed of the environment—which may be utilized by users, such as architects, historians, and designers.

In other embodiments, a spatially aware pointer can be plugged into the data port of a tablet computer to provide hand gesture sensing. A user can then make hand gestures near the tablet computer to interact with a remote TV set, such as changing TV channels.

In other embodiments, a spatially aware pointer can be operatively coupled to a mobile phone having a built-in image projector. A user can make a hand gesture near the mobile phone to move a cursor across a remote projected image, or touch a remote surface to modify the projected image.

In yet other embodiments, a spatially aware pointer can determine the position and orientation of other spatially aware pointers in the vicinity, including where such pointers are aimed. Such a feature enables a plurality of pointers and their respective host appliances to interact, such as a plurality of mobile phones with interactive projected images.

### BRIEF DESCRIPTION OF THE DRAWINGS

The following exemplary embodiments of the invention will now be described by way of example with reference to the accompanying drawings:

FIG. 1 is a block diagram view of a first embodiment of a spatially aware pointer, which has been operatively coupled to a host appliance.

FIG. 2A is a perspective view of the pointer of FIG. 1, where the pointer is not yet operatively coupled to its host appliance.

FIG. 2B is a perspective view of the pointer of FIG. 1, where the pointer has been operatively coupled to its host appliance.

FIG. 2C is a perspective view of two users with two pointers of FIG. 1, where one pointer has illuminated a pointer indicator on a remote surface.

FIG. 3A is a sequence diagram that presents discovery, configuration, and operation of the pointer and host appliance of FIG. 1.

FIG. 3B is a data table that defines pointer data settings for the pointer of FIG. 1.

FIG. 4 is a flow chart of a high-level method for the pointer of FIG. 1.

FIG. 5A is a perspective view of a hand gesture being made substantially near the pointer of FIG. 1 and its host appliance, which has created a projected image.

FIG. 5B is a top view of the pointer of FIG. 1, along with its host appliance showing a projection field and a view field.

FIG. 6 is a flow chart of a viewing method for the pointer of FIG. 1.

FIG. 7 is a flow chart of a gesture analysis method for the pointer of FIG. 1.

FIG. 8A is a data table that defines a message data event for the pointer of FIG. 1.

FIG. 8B is a data table that defines a gesture data event for the pointer of FIG. 1.

FIG. 8C is a data table that defines a pointer data event for the pointer of FIG. 1.

FIG. 9A is a perspective view (in visible light) of a hand gesture being made substantially near the pointer of FIG. 1, including its host appliance having a projected image.

FIG. 9B is a perspective view (in infrared light) of a hand gesture being made substantially near the pointer of FIG. 1.

FIG. 9C is a perspective view (in infrared light) of a hand touching a remote surface substantially near the pointer of FIG. 1.

FIG. 10 is a flow chart of a touch gesture analysis method for the pointer of FIG. 1.

FIG. 11 is a perspective view of the pointer of FIG. 1, wherein pointer and host appliance are being calibrated for a touch-sensitive workspace.

FIG. 12 is a perspective view of the first pointer of FIG. 1 and a second pointer, wherein first and second pointers along with host appliances have created a shared workspace.

FIG. 13 is a sequence diagram of the first pointer of FIG. 1 and second pointer, wherein first and second pointers along with host appliances are operating a shared workspace.

FIG. 14 is a perspective view of the pointer of FIG. 1, wherein the pointer is illuminating a pointer indicator on a remote surface.

FIG. 15 is an elevation view of some alternative pointer indicators.

FIG. 16 is an elevation view of a spatially aware pointer that illuminates a plurality of pointer indicators.

FIG. 17A is a perspective view of an indicator projector for the pointer of FIG. 1.

FIG. 17B is a top view of an optical medium of the indicator projector of FIG. 17A.

FIG. 17C is a section view of the indicator projector of FIG. 17A.

FIG. 18 is a perspective view of an alternative indicator projector, which is comprised of a plurality of light sources.

FIG. 19 is a perspective view of an alternative indicator projector, which is an image projector.

FIG. 20 is a sequence diagram of spatial sensing operation of the first pointer of FIG. 1 and a second pointer, along with their host appliances.

FIG. 21A is a perspective view of the first pointer of FIG. 1 and a second pointer, wherein the first pointer is 3D depth sensing a remote surface.

FIG. 21B is a perspective view of the first and second pointers of FIG. 21A, wherein the second pointer is sensing a pointer indicator from the first pointer.

FIG. 21C is a perspective view of the second pointer of FIG. 21A, showing 3-axis orientation in Cartesian space.

FIG. 22A is a perspective view of the first and second pointers of FIG. 21A, wherein the second pointer is 3D depth sensing a remote surface.

FIG. 22B is a perspective view of the first and second pointers of FIG. 21A, wherein the first pointer is sensing a pointer indicator from the second pointer.

FIG. 23 is a flow chart of an indicator maker method for the pointer of FIG. 1.

FIG. 24 is a flow chart of a pointer indicator analysis method for the pointer of FIG. 1.

FIG. 25 is a perspective view of the spatial calibration of the first and second pointers of FIG. 21A, along with their respective host appliances.

FIG. 26 is a perspective view of the first and second pointers of FIG. 21A, along with host appliances that have created projected images that appear to interact.

FIG. 27 is a perspective view of the first and second pointers of FIG. 21A, along with host appliances that have created a combined projected image.

FIG. 28 is a perspective view of the pointer of FIG. 1 that communicates with a remote device (e.g., TV set) in response to a hand gesture.

FIG. 29A is a flow chart of a send data message method of the pointer of FIG. 1.

FIG. 29B is a flow chart of a receive data message method of the pointer of FIG. 1.

FIG. 30 is a block diagram view of a second embodiment of a spatially aware pointer, which uses an array-based indicator projector and viewing sensor.

FIG. 31A is a perspective view of the pointer of FIG. 30, along with its host appliance.

FIG. 31B is a close-up view of the pointer of FIG. 30, showing the array-based viewing sensor.

FIG. 32 is a perspective view of the first pointer of FIG. 30 and a second pointer, showing pointer indicator sensing.

FIG. 33 is a block diagram view of a third embodiment of a spatially aware pointer, which has enhanced 3D spatial sensing.

FIG. 34 is a perspective view of the pointer of FIG. 33, along with its host appliance.

FIG. 35A is a perspective view of the pointer of FIG. 33, wherein a pointer indicator is being illuminated on a plurality of remote surfaces.

FIG. 35B is an elevation view of a captured light view of the pointer of FIG. 35A.

FIG. 35C is a detailed elevation view of the pointer indicator of FIG. 35A.

FIG. 36 is a flow chart of a high-level method of operations of the pointer of FIG. 33.

FIG. 37A is a flow chart of a method for 3D depth sensing by the pointer of FIG. 33.

FIG. 37B is a flow chart of a method for detecting remote surfaces and objects by the pointer of FIG. 33.

FIG. 38 is a perspective view of the pointer of FIG. 33, along with its host appliance that has created a projected image with reduced distortion.

FIG. 39 is a flow chart of a method for the pointer and appliance of FIG. 38 to create a projected image with reduced distortion.

FIG. 40A is a perspective view (in infrared light) of the pointer of FIG. 33, wherein a user is making a hand gesture.

FIG. 40B is a perspective view (in visible light) of the pointer and hand gesture of FIG. 40A.

FIG. 41A is a perspective view (in infrared light) of the pointer of FIG. 33, wherein a user is making a touch gesture.

FIG. 41B is a perspective view (in visible light) of the pointer and touch gesture of FIG. 41A.

FIG. 42A is a perspective view of the first pointer and a second pointer of FIG. 33, wherein the first pointer is 3D depth sensing a remote surface.

FIG. 42B is a perspective view of the first and second pointers of FIG. 42A, wherein the second pointer is sensing a pointer indicator from the first pointer.

FIG. 42C is a perspective view of the second pointer of FIG. 42A, showing 3-axis orientation in Cartesian space.

FIG. 42D is a perspective view of the first and second pointers of FIG. 42A, along with host appliances that have created projected images that appear to interact.

FIG. 43 is a block diagram of a fourth embodiment of a spatially aware pointer, which uses structured light to construct a 3D spatial model of an environment.

FIG. 44 is a perspective view of the pointer of FIG. 43, along with a host appliance.

FIG. 45 is a perspective view of a user moving the appliance and pointer of FIG. 43 through 3D space, creating a 3D model of at least a portion of an environment.

FIG. 46 is a flowchart of a 3D spatial mapping method for the pointer of FIG. 43.

FIG. 47 is a block diagram of a fifth embodiment of a spatially aware pointer, which uses stereovision to construct a 3D spatial model of an environment.

FIG. 48 is a perspective view of the pointer of FIG. 47, along with a host appliance.

### DETAILED DESCRIPTION OF THE INVENTION

One or more specific embodiments will be discussed below. In an effort to provide a concise description of these embodiments, not all features of an actual implementation are described in the specification. It should be appreciated that when actually implementing embodiments of this invention, as in any product development process, many decisions must be made. Moreover, it should be appreciated that such a design effort could be quite labor intensive, but would nevertheless be a routine undertaking of design and construction for those of ordinary skill having the benefit of this disclosure. Some helpful terms of this discussion will be defined:

The terms “a”, “an”, and “the” refers to one or more items. Where only one item is intended, the terms “one”, “single”, or similar language is used. Also, the terms “include”, “has”, and “have” mean “comprise”. The term “and/or” refers to any and all combinations of one or more of the associated list items.

The terms “adapter”, “analyzer”, “application”, “circuit”, “component”, “control”, “function”, “interface”, “method”, “module”, “program”, and like terms are intended to include hardware, firmware, and/or software.

The term “barcode” refers to any optical machine-readable representation of data, such as one-dimensional (1D) or two-dimensional (2D) barcodes or symbols.

The term “computer readable medium” or the like refers to any type or combination of types of medium for retaining information in any form or combination of forms, including various types of storage devices (e.g., magnetic, optical, and/or solid state, etc.). The term “computer readable medium” also encompasses transitory forms of representing information, including various hardwired and/or wireless links for transmitting the information from one point to another.

The term “haptic” refers to vibratory or tactile stimulus presented to a user, often provided by a vibrating or haptic device when placed near the user's skin. A “haptic signal” refers to a signal that operates a haptic device.

The terms “key”, “keypad”, “key press”, and like terms are meant to broadly include all types of user input interfaces and their respective action, such as, but not limited to, a gesture-sensitive camera, a touch pad, a keypad, a control button, a trackball, and/or a touch sensitive display.

The term “multimedia” refers to media content and/or its respective sensory action, such as, but not limited to, video, graphics, text, audio, haptic, user input events, universal resource locator (URL) data, computer executable instructions, and/or computer data.

The term “operatively coupled” refers to a wireless and/or a wired means of communication between items, unless otherwise indicated. Moreover, the term “operatively coupled” may further refer to a direct coupling between items and/or an indirect coupling between items via an intervening item or items (e.g., an item includes, but not limited to, a component, a circuit, a module, and/or a device). The term “wired” refers to any type of physical communication conduits (e.g., electronic wires, traces, and/or optical fibers).

The term “optical” refers to any type of light or usage of light, both visible (e.g., white light) and/or invisible light (e.g., infrared light), unless specifically indicated.

The term “video” generally refers to a sequence of video frames that may be used, for example, to create an animated image.

The term “video frame” refers to a single still image, e.g., a digital graphic image.

The present disclosure illustrates examples of operations and methods used by the various embodiments described. Those of ordinary skill in the art will readily recognize that certain steps or operations described herein may be eliminated, taken in an alternate order, and/or performed concurrently. Moreover, the operations may be implemented as one or more software programs for a computer system and encoded in a computer readable medium as instructions executable by one or more processors. The software programs may also be carried in a communications medium conveying signals encoding the instructions. Separate instances of these programs may be executed by separate computer systems. Thus, although certain steps have been described as being performed by certain devices, software programs, processes, or entities, this need not be the case and a variety of alternative implementations will be understood by those having ordinary skill in the art.

The following detailed description refers to the accompanying drawings. The same reference numbers in different drawings identifies the same or similar elements.

### First Embodiment of a Spatially Aware Pointer

Turning now to FIG. 1, thereshown is a block diagram illustrating a first embodiment of a spatially aware pointer 100. The spatially aware pointer 100 may be attached to and operatively coupled to a pre-existing host appliance 50 that is mobile and handheld, as shown in perspective views of FIGS. 2A-2C. Whereby. FIG. 2C shows a user 202 can move the pointer 100 and appliance 50 about three-dimensional (3D) space in an environment, where appliance 50 has been augmented with remote control, hand gesture detection, and 3D spatial depth sensing abilities. The spatially aware pointer 100 and host appliance 50 may inter-operate as a spatially aware pointer system.

### Example of a Host Appliance

As shown in FIG. 1, host appliance 50 represents just one example of a pre-existing electronic appliance that may be used by a spatially aware pointer, such as pointer 100. A host appliance can be mobile and handheld (as host appliance 50), mobile, and/or stationary. As illustrative examples, host appliance 50 can be a mobile phone, a personal digital assistant, a personal data organizer, a laptop computer, a tablet computer, a personal computer, a network computer, a stationary projector, a mobile projector, a handheld pico projector, a mobile digital camera, a portable video camera, a television (TV) set, a mobile television, a communication terminal, a communication connector, a remote controller, a game controller, a game console, a media recorder, or a media player, or any other similar, yet to be developed appliance.

FIG. 1 shows that host appliance 50 may be comprised of, but not limited to, a host image projector 52 (optional), a host user interface 60, a host control unit 54, a host wireless transceiver 55, a host memory 62, a host program 56, a host data controller 58, a host data coupler 161, and a power supply 59. Alternative embodiments of host appliances with different hardware and/or software configurations may also be utilized by pointer 100. For example, the host image projector 50 is an optional component (as illustrated by dashed lines in FIG. 1) and is not required for usage of some embodiments of a spatially aware pointer.

In the current embodiment, the host image projector 52 may be an integrated component of appliance 50 (FIGS. 1 and 2A). Projector 52 can be comprised of a compact image projector (e.g., “pico” projector) that can create a projected image 220 (FIG. 2C) on one or more remote surfaces 224 (FIG. 2C), such as a wall and/or ceiling. In alternate embodiments, image projector 52 may be an external device operatively coupled to appliance 50 (e.g., a cable, adapter, and/or wireless video interface). In alternate embodiments, host appliance 50 does not include an image projector.

The host data controller 58 may be operatively coupled to the host data coupler 161, enabling communication and/or power transfer with pointer 100 via a data interface 111. Whereby, the data interface 111 may form a wired and/or wireless communication interface between pointer 100 and host appliance 50. The data controller 58 may be comprised of at least one wired and/or wireless data controller. Data controller 58 may be comprised of at least one of a USB-, RS-232-, UART-, Apple (e.g., 30 pin, Lightning, etc.)-, IEEE 1394 “Firewire”-, Ethernet-, video-, Mobile High-Definition Link (MHL)-, phone cellular-, audio-, MIDI-, serial-, parallel-, infrared-, optical-, wireless USB-, Bluetooth-, Near Field Communication-, WiFi-based data controller, or some combination thereof although another type of data controller can be used as well.

The host data coupler 161 may be comprised of at least one of a USB connector, a mini USB connector, a micro USB connector, an Apple connector, a 30-pin connector, an 8-pin connector, an IEEE 1394 “Firewire” connector, an Ethernet connector, a video connector, a Mobile High-Definition Link connector, a phone connector, an audio connector, a TRS connector, a MIDI connector, a serial connector, a parallel connector, an inductive interface, a wireless antenna, an infrared interface, an optical interface, a wireless USB interface, a Bluetooth interface, a Near Field Communication interface, a WiFi interface, or some combination thereof, although another type of data coupler can be used as well.

Further, host appliance 50 may include the wireless transceiver 55 for wireless communication with remote devices (e.g., wireless router, wireless WiFi router, and/or other types of remote devices) and/or remote networks (e.g., cellular phone communication network, WiFi network, wireless local area network, wireless wide area network, Internet, and/or other types of networks). In some embodiments, host appliance 50 may be able to communicate with the Internet. Wireless transceiver 55 may be comprised of one or more wireless communication transceivers (e.g., Near Field Communication transceiver, RF transceiver, optical transceiver, infrared transceiver, and/or ultrasonic transceiver) that utilize one or more data protocols (e.g., WiFi, TCP/IP, Zigbee, Wireless USB, Bluetooth, Near Field Communication, Wireless Home Digital Interface (WHDI), cellular phone protocol, and/or other types of protocols).

The host user interface 60 may include at least one user input device, such as, for example, a keypad, touch pad, control button, mouse, trackball, and/or touch sensitive display.

Appliance 50 can include memory 62, a computer readable medium that may be comprised of RAM, ROM, Flash, Secure Digital (SD) card, and/or hard drive, as illustrative examples.

Host appliance 50 can be operably managed by the host control unit 54 comprised of at least one microprocessor to execute computer instructions of, but not limited to, the host program 56. Host program 56 may include computer executable instructions (e.g., operating system, drivers, and/or applications) and/or data.

Finally, host appliance 50 may include power supply 59 comprised of an energy storage battery (e.g., rechargeable battery) and/or external power cord.

### Components of the Spatially Aware Pointer

FIG. 1 also presents components of the spatially aware pointer 100, which may be comprised of but not limited to, a pointer data controller 110, a pointer data coupler 160, a memory 102, data storage 103, a pointer control unit 108, a power supply circuit 112, an indicator projector 124, a gesture projector 128, and a viewing sensor 148.

The pointer data controller 110 may be operatively coupled to the pointer data coupler 160, enabling communication and/or electrical energy transfer with appliance 50 via the data interface 111. Whereby, the data interface 111 may form a wired and/or wireless communication interface between pointer 100 and host appliance 50. The data controller 110 may be comprised of at least one wired and/or wireless data controller. Data controller 110 may be comprised of at least one of a USB-, RS-232-, UART-, Apple (e.g., 30 pin, Lightning, etc.)-, IEEE 1394 “Firewire”-, Ethernet-, video-, Mobile High-Definition Link (MHL)-, phone cellular-, audio-, MIDI-, serial-, parallel-, infrared-, optical-, wireless USB-, Bluetooth-, Near Field Communication-, WiFi-based data controller, or some combination thereof, although another type of data controller can be used as well.

The pointer data coupler 160 may be comprised of at least one of a USB connector, a mini USB connector, a micro USB connector, an Apple connector, a 30-pin connector, an 8-pin connector, an IEEE 1394 “Firewire” connector, an Ethernet connector, a video connector, a Mobile High-Definition Link connector, a phone connector, an audio connector, a TRS connector, a MIDI connector, a serial connector, a parallel connector, an inductive interface, a wireless antenna, an infrared interface, an optical interface, a wireless USB interface, a Bluetooth interface, a Near Field Communication interface, a WiFi interface, or some combination thereof, although another type of data coupler can be used as well.

Memory 102 may be comprised of computer readable medium for retaining, for example, computer executable instructions. Memory 102 may be comprised of RAM, ROM, Flash, Secure Digital (SD) card, and/or hard drive, although other memory types in whole, part, or combination may be used, including fixed or removable, volatile or nonvolatile memory.

Data storage 103 may be comprised of computer readable medium for retaining, for example, computer data. Data storage 103 may be comprised of RAM, ROM, Flash, Secure Digital (SD) card, and/or hard drive, although other memory types in whole, part, or combination may be used, including fixed or removable, volatile or nonvolatile memory. Although memory 102, data storage 103, and data controller 110 are presented as separate components, some alternate embodiments of a spatially aware pointer may use an integrated architecture, e.g., where memory 102, data storage 103, data controller 110, data coupler 160, power supply circuit 112, and/or control unit 108 may be wholly or partially integrated.

Operably managing the pointer 100, the pointer control unit 108 may include at least one microprocessor having appreciable processing speed (e.g., 1 gHz) to execute computer instructions. Control unit 108 may include microprocessors that are general-purpose and/or special purpose (e.g., graphic processors, video processors, and/or related chipsets). The control unit 108 may be operatively coupled to, but not limited to, memory 102, data storage 103, data controller 110, indicator projector 124, gesture projector 128, and viewing sensor 148.

Finally, electrical energy to operate the pointer 100 may come from the power supply circuit 112, which may receive energy from interface 111. In some embodiments, data coupler 160 may include a power transfer coupler (e.g., Multi-pin Docking port, USB port, IEEE 1394 “Firewire” port, power connector, or wireless power transfer interface) that enables transfer of energy from an external device, such as appliance 50, to circuit 112 of pointer 100. Whereby, circuit 112 may receive and distribute energy throughout pointer 100, such as to, but not limited to, control unit 108, memory 102, data storage 103, controller 110, indicator projector 124, gesture projector 128, and viewing sensor 148. Circuit 112 may optionally include power regulation circuitry adapted from current art. In some embodiments, circuit 112 may include an energy storage battery to augment or replace any external power supply.

### Indicator Projector and Gesture Projector

FIG. 1 shows the indicator projector 124 and gesture projector 128 may each be operatively coupled to the pointer control unit 108, such that the control unit 108 can independently control the projectors 124 and 128 to generate light from pointer 100.

The indicator projector 124 and gesture projector 128 may each be comprised of at least one infrared light emitting diode or infrared laser diode that creates infrared light, unseen by the naked eye. In alternative embodiments, indicator projector 124 and gesture projector may each be comprised of at least one light emitting diode (LED)-, organic light emitting diode (OLED)-, fluorescent-, electroluminescent (EL)-, incandescent-, and/or laser-based light source that emits visible light (e.g., red) and/or invisible light (e.g., infrared or ultraviolet), although other types, combinations, and numbers of light sources may be considered.

In some embodiments, indicator projector 124 and/or gesture projector 128 may be comprised of an image projector (e.g., pico projector), such that indicator projector 124 and/or gesture projector 128 can project an illuminated shape, pattern, or image onto a remote surface.

In some embodiments, indicator projector 124 and/or gesture projector 128 may include an electronic switching circuit (e.g., amplifier, codec, etc.) adapted from current art, such that pointer control unit 108 can control the generated light from the indicator projector 124 and/or the gesture projector 128.

In the current embodiment, the gesture projector 128 may specifically generate light for gesture detection and 3D spatial sensing. The gesture projector 128 may generate a wide-angle light beam (e.g., light projection angle of 20-180 degrees) that projects outward from pointer 100 and can illuminate one or more remote objects, such as a user hand or hands making a gesture (e.g., as in FIG. 2C, reference numeral G). In alternative embodiments, gesture projector may generate one or more light beams of any projection angle.

In the current embodiment, the indicator projector 124 may generate light specifically for remote control (e.g. such as detecting other spatially aware pointers in the vicinity) and 3D spatial sensing. The indicator projector 124 may generate a narrow-angle light beam (e.g., light projection angle 2-20 degrees) having a predetermined shape or pattern of light that projects outward from pointer 100 and can illuminate a pointer indicator (e.g., as in FIG. 2C, reference numeral 296) on one or more remote surfaces, such as a wall or floor, as illustrative examples. In alternative embodiments, indicator projector may generate one or more light beams of any projection angle.

### Viewing Sensor

FIG. 1 shows the viewing sensor 148 may be operatively coupled to the pointer control unit 108 such that the control unit 108 can control and take receipt of one or more light views (or image frames) from the viewing sensor 108. The viewing sensor 148 may be comprised of at least one light sensor operable to capture one or more light views (or image frames) of its surrounding environment.

In the current embodiment, the viewing sensor 148 may be comprised of a complementary metal oxide semiconductor (CMOS)- or a charge coupled device (CCD)-based image sensor that is sensitive to at least infrared light. In alternative embodiments, the viewing sensor 148 may be comprised of at least one image sensor-, photo diode-, photo detector-, photo detector array-, optical receiver-, infrared receiver-, and/or electronic camera-based light sensor that is sensitive to visible light (e.g., white, red, blue, etc.) and/or invisible light (e.g., infrared or ultraviolet), although other types, combinations, and/or numbers of viewing sensors may be considered. In some embodiments, viewing sensor 148 may comprised of a 3D-depth camera, often referred to as a ranging, lidar, time-of-flight, stereo pair, or RGB-D camera, which creates a 3-D spatial depth light view. Finally, the viewing sensor 148 may be further comprised of light sensing support circuitry (e.g., memory, amplifiers, etc.) adapted from current art.

### Computer Implemented Methods of the Pointer

FIG. 1 shows memory 102 may be comprised of various functions having computer executable instructions, such as an operating system 109, and a pointer program 114. Such functions may be implemented in software, firmware, and/or hardware. In the current embodiment, these functions may be implemented in memory 102 and executed by control unit 108.

The operating system 109 may provide pointer 100 with basic functions and services, such as read/write operations with hardware.

The pointer program 114 may be comprised of, but not limited to, an indicator encoder 115, an indicator decoder 116, an indicator maker 117, a view grabber 118, a depth analyzer 119, a surface analyzer 120, an indicator analyzer 121, and a gesture analyzer 122.

The indicator maker 117 coordinates the generation of light from the indicator projector 124 and the gesture projector 128, each being independently controlled.

Contrarily, the view grabber 118 may coordinate the capture of one or more light views (or image frames) from the viewing sensor 148 and storage as captured view data 104. Subsequent functions may then analyze the captured light views.

For example, the depth analyzer 119 may provide pointer 100 with 3D spatial sensing abilities. In some embodiments, depth analyzer 119 may be operable to analyze light on at least one remote surface and determine one or more spatial distances to the at least one remote surface. In certain embodiments, the depth analyzer 119 can generate one or more 3D depth maps of an at least one remote surface. Depth analyzer 119 may be comprised of, but not limited to, a time-of-flight-, stereoscopic-, or triangulation-based 3D depth analyzer that uses computer vision techniques. In the current embodiment, a triangulation-based 3D depth analyzer will be used.

The surface analyzer 120 may be operable to analyze one or more spatial distances to an at least one remote surface and determine the spatial position, orientation, and/or shape of the at least one remote surface. In some embodiments, surface analyzer 120 may detect an at least one remote object and determine the spatial position, orientation, and/or shape of the at least one remote object. In certain embodiments, the surface analyzer 120 can transform a plurality of 3D depth maps and create at least one 3D spatial model that represents at least a portion of an environment, one or more remote objects, and/or at least one remote surface.

The indicator analyzer 121 may be operable to detect at least a portion of an illuminated pointer indicator (e.g., FIG. 2C, reference numeral 296), such as, for example, from another pointer and determine the spatial position, orientation, and/or shape of the pointer indicator from the other pointer. The indicator analyzer 121 may optionally include an optical barcode reader for reading optical machine-readable representations of data, such as illuminated 1D- or 2D-barcodes. Indicator analyzer 121 may rely on computer vision techniques (e.g., pattern recognition, projective geometry, homography, camera-based barcode reader, and/or camera pose estimation) adapted from current art. Whereupon, the indicator analyzer 121 may be able to create and transmit a pointer data event to appliance 50.

The gesture analyzer 122 may be able to detect one or more hand gestures and/or touch hand gestures being made by a user in the vicinity of pointer 100. Gesture analyzer 122 may rely on computer vision techniques (e.g., hand detection, hand tracking, and/or gesture identification) adapted from current art. Whereupon, gesture analyzer 122 may be able to create and transmit a gesture data event to appliance 50.

Further included with pointer 100, the indicator encoder 115 may be able to transform a data message into an encoded light signal, which is transmitted to the indicator projector 124 and/or gesture projector 128. Wherein, data-encoded modulated light may be projected by the indicator projector 124 and/or gesture projector 128 from pointer 100.

To complement this feature, the indicator decoder 116 may be able to receive an encoded light signal from the viewing sensor 148 and transform it into a data message. Hence, data-encoded modulated light may be received and decoded by pointer 100. Data encoding/decoding, modulated light functions may be adapted from current art.

### Computer Implemented Data of the Pointer

FIG. 1 also shows data storage 103 that includes various collections of computer implemented data (or data sets), such as, but not limited to, captured view data 104, spatial cloud data 105, tracking data 106, and event data 107. These data sets may be implemented in software, firmware, and/or hardware. In the current embodiment, these data sets may be implemented in data storage 103, which can be read from and/or written to (or modified) by control unit 108.

For example, the captured view data 104 may provide storage for one or more captured light views (or image frames) from the viewing sensor 148 for pending view analysis. View data 104 may optionally include a look-up catalog such that light views can be located by type, time stamp, etc.

The spatial cloud data 105 may retain data describing, but not limited to, the spatial position, orientation, and shape of remote surfaces, remote objects, and/or pointer indicators (from other devices). Spatial cloud data 105 may include geometrical figures in 3D Cartesian space. For example, geometric surface points may correspond to points residing on physical remote surfaces external of pointer 100. Surface points may be associated to define geometric 2D surfaces (e.g., polygon shapes) and 3D meshes (e.g., polygon mesh of vertices) that correspond to one or more remote surfaces, such as a wall, table top, etc. Finally, 3D meshes may be used to define geometric 3D objects (e.g., 3D object models) that correspond to remote objects, such as a user's hand.

Tracking data 106 may provide storage for, but not limited to, the spatial tracking of remote surfaces, remote objects, and/or pointer indicators. For example, pointer 100 may retain a history of previously recorded position, orientation, and shape of remote surfaces, remote objects (such as a user's hand), and/or pointer indicators defined in the spatial cloud data 105. This enables pointer 100 to interpret spatial movement (e.g., velocity, acceleration, etc.) relative to external remote surfaces, remote objects (such as a user hand making a gesture), and pointer indicators (e.g., from other spatially aware pointers).

Finally, event data 107 may provide information storage for one or more data events. A data event can be comprised of one or more computer data packets (e.g., 10 bytes) and/or electronic signals, which may be communicated between the pointer control unit 108 of pointer 100 and the host control unit 62 of host appliance 50 via the data interface 111. Whereby, the term “data event signal” refers to one or more electronic signals associated with a data event. Data events may include, but not limited to, gesture data events, pointer data events, and message data events that convey information between the pointer 100 and host appliance 50.

### Housing of the Spatially Aware Pointer

Turning now to FIG. 2A, thereshown is a perspective view of the spatially aware pointer 100 uncoupled from the host appliance 50, for illustrative purposes. Pointer 100 may be a mobile device of substantially compact size (e.g., 15 mm wide×10 mm high×40 mm deep) comprised of a housing 170 with indicator projector 124 and viewing sensor 148 positioned in (or in association with) the housing 170 at a front end 172. Housing 170 may be constructed of any size and shape and made suitable materials (e.g., plastic, rubber, etc.). In some embodiments, indicator projector 124 and/or viewing sensor 148 may be positioned within (or in association with) housing 170 at a different location and/or orientation for unique sensing abilities.

A communication interface can be formed between pointer 100 and appliance 50. As can be seen, the pointer 100 may be comprised of at least one data coupler 160 implemented as, for example, a male connector (e.g., male USB connector, male Apple® (e.g., 30 pin, Lightning, etc.) connector, etc.). To complement this, appliance 50 may be comprised of the data coupler 161 implemented as, for example, a female connector (e.g., female USB connector, female Apple connector, etc.). In alternative embodiments, coupler 160 may be a female connector or agnostic.

Appliance 50 can include the host image projector 52 mounted at a front end 72, so that projector 52 may illuminate a visible projected image (not shown). Appliance 50 may further include the user interface 60 (e.g., touch sensitive interface).

### Enabling the Spatially Aware Pointer

Continuing with FIG. 2A, a user (not shown) may enable operation of pointer 100 by moving pointer 100 towards appliance 50 and operatively coupling the data couplers 160 and 161. In some embodiments, data coupler 160 may include or be integrated with a data adapter (e.g., rotating coupler, pivoting coupler, coupler extension, and/or data cable) such that pointer 100 is operatively coupled to appliance 50 in a desirable location. In certain embodiments, housing 170 may include an attachment device, such as, but not limited to, a strap-on, a clip-on, and/or a magnetic attachment device that enables pointer 100 to be physically held or attached to appliance 50.

FIG. 2B shows a perspective view of the spatially aware pointer 100 operatively coupled to the host appliance 50, enabling pointer 100 to begin operation. As best seen in FIG. 1, electrical energy from host appliance 50 may flow through data interface 111 to power supply circuit 112. Circuit 112 may then distribute electrical energy to, for example, control unit 108, memory 102, data storage 103, controller 110, indicator projector 124, gesture projector 128, and viewing sensor 148. Whereupon, pointer 100 and appliance 50 may begin to communicate using data interface 111.

### Start-Up Method of Operation

FIG. 3A presents a sequence diagram of a computer implemented, start-up method for a spatially aware pointer and its respective host appliance. The operations for pointer 100 may be implemented in pointer program 114 and executed by the pointer control unit 108, while operations for appliance 50 may be implemented in host program 56 and executed by host control unit 54 (FIG. 1).

Starting with step S50, pointer 100 and host appliance 50 may discover each other by exchanging signals via the data interface (FIG. 1, reference numeral 111). Whereby, in step S52, the pointer 100 and appliance 50 can create a data communication link by, for example, using communication technology (e.g., “plug-and-play”) adapted from current art.

In step S53, the pointer 100 and host appliance 50 may configure and share pointer data settings so that both devices can interoperate. Such data settings (e.g., FIG. 3B) may be acquired, for example, from the pointer's 100 operating system API, host appliance's 50 operating system API, and/or manually entered by a user via the appliance's user interface at start-up.

Finally, in steps S54 and S56, the pointer 100 and appliance 50 can continue executing their respective programs. As best seen in FIG. 1, pointer control unit 108 may execute instructions of operating system 109 and pointer program 114. Host control unit 54 may execute host program 56, maintaining data communication with pointer 100 by way of interface 111. Host program 56 may further include a device driver that discovers and communicates with pointer 100, such as taking receipt of data events from pointer 100.

### Data Settings for Pointer

FIG. 3B presents a data table of example pointer data settings D50 comprised of configuration data so that the pointer and appliance can interoperate. Data settings D50 may be stored in data storage (FIG. 1, reference numeral 103). Data settings D50 can be comprised of data attributes, such as, but not limited to, a pointer id D51, an appliance id D52, a display resolution D54, and projector throw angles D56.

Pointer id D51 can designate a unique identifier for spatially aware pointer (e.g., Pointer ID=“100”).

Appliance id D52 can designate a unique identifier for host appliance (e.g., Appliance ID=“50”).

Display resolution D54 can define the host display dimensions (e.g., Display resolution=[1200 pixels wide, 800 pixels high]).

Projector throw angles D56 can define the host image projector light throw angles (e.g., Projector Throw Angles=[30 degrees for horizontal throw, 20 degrees for vertical throw]).

### High-Level Method of Operation for Pointer

Turning now to FIG. 4, a flowchart of a high-level, computer implemented method of operation for the spatially aware pointer is presented, although alternative methods may be considered. The method may be implemented in pointer program 114 and executed by the pointer control unit 108 (FIG. 1). The method may be considered a simplified overview of operations (e.g., start-up, light generation, light view capture, and analysis) as more detailed instructions will be presented further in this discussion.

Beginning with step S100, the pointer control unit 108 may initialize the pointer's 100 hardware, firmware, and/or software by, for example, setting memory 102 and data storage 103 with default data.

In step S102, pointer control unit 108 and indicator maker 117 may briefly enable the indicator projector 124 and/or the gesture projector 128 to project light onto an at least one remote surface, such as a wall, tabletop, and/or a user hand, as illustrative examples. Whereby, the indicator projector 124 may project a pointer indicator (e.g., FIG. 2C, reference 296) on the at least one remote surface.

Then in step S103 (which may be substantially concurrent with step S102), the pointer control unit 108 and view grabber 117 may enable the viewing sensor 148 to capture one or more light views of the at least one remote surface, and store the one or more light views in captured view data 104 of data storage 103 for future reference.

Whereupon, in step S104, pointer control unit 108 and indicator decoder 116 may take receipt of at least one light view from view data 104 and analyze the light view(s) for data-encoded light effects. Whereupon, any data-encoded light present may be transformed into data to create a message data event in event data 107. The message data event may subsequently be transmitted to the host appliance 50.

Continuing to step S105, pointer control unit 108 and gesture analyzer 122 may take receipt of at least one light view from view data 104 and analyze the light view(s) for remote object gesture effects. Whereby, if one or more remote objects, such as a user hand or hands, are observed making a recognizable gesture (e.g., “thumbs up”), then a gesture data event (e.g., gesture type, position, etc.) may be created in event data 107. The gesture data event may subsequently be transmitted to the host appliance 50.

Then in step S106, pointer control unit 108 and indicator analyzer 121 may take receipt of at least one light view from view data 104 and analyze the light view(s) for a pointer indicator. Whereby, if at least a portion of a pointer indicator (e.g., FIG. 2C, reference 296) is observed and recognized, then a pointer data event (e.g., pointer id, position, etc.) may be created in event data 107. The pointer data event may subsequently be transmitted to the host appliance 50.

Continuing to step S107, pointer control unit 108 may update pointer clocks and timers so that some operations of pointer may be time coordinated.

Then in step S108, if pointer control unit 108 determines a predetermined time period has elapsed (e.g., 0.05 second) since the previous light view(s) was captured, the method returns to step S102. Otherwise, the method returns to step S107 so that clocks and timers are maintained.

As may be surmised, the method of FIG. 4 may enable the spatially aware pointer to capture and/or analyze a collection of captured light views. This processing technique may enable the pointer 100 to transmit message, gesture, and pointer data events in real-time to host appliance 50. Whereby, the host appliance 50, along with its host control unit 54 and host program 56, may utilize the received data events during execution of an application (e.g., interactive video display), such as responding to a hand gesture.

### Detecting Hand Gestures

Now turning to FIG. 5A, a perspective view of the pointer 100, appliance 50, and a hand gesture is presented. A user (not shown) with user hand 200 is positioned forward of pointer 100. Moreover, appliance 50 and projector 52 illuminate a projected image 220 on a remote surface 224, such as, for example, a wall or tabletop. The projected image 220 includes a graphic element 212 and a moveable graphic cursor 210.

During an example operation, the hand 200 may be moved through space along move path M1 (denoted by an arrow). Pointer 100 and its viewing sensor 148 may detect and track the movement of at least one object, such as hand 200 or multiple hands (not shown). Pointer 100 may optionally enable the gesture projector 128 to project light to enhance visibility of hand 200. Whereupon, the pointer 100 and its gesture analyzer (FIG. 1, reference numeral 122) can create a gesture data event (e.g., Gesture Type=MOVING CURSOR, Gesture Position=[10,10,20], etc.) and transmit the gesture data event to appliance 50.

Appliance 50 can take receipt of the gesture data event and may generate multimedia effects. For example, appliance 50 may modify projected image 220 with a graphic cursor 210 that moves across image 220, as denoted by a move path M2. As illustrated, move path M2 of cursor 210 may substantially correspond to move path M1 of the hand 200. That is, as hand 200 moves left, right, up, or down, the cursor 210 moves left, right, up, or down, respectively.

In alternative embodiments, cursor 210 may depict any type of graphic shape (e.g., reticle, sword, gun, pen, or graphical hand). In some embodiments, pointer 100 can respond to other types of hand gestures, such as one-, two- or multi-handed gestures, including but not limited to, a thumbs up, finger wiggle, hand wave, open hand, closed hand, two-hand wave, and/or clapping hands.

FIG. 5A further suggests pointer 100 may optionally detect the user hand 200 without interfering with the projected image 220 and forming an obtrusive shadow.

So turning to FIG. 5B, a top view of pointer 100 and its viewing sensor 148 is presented, along with the host appliance 50 and its projector 52. Projector 52 illuminates image 220 on remote surface 224. Wherein, projector 52 may have a predetermined light projection angle PA creating a projection field PF. Further, viewing sensor 148 may have a predetermined light view angle VA where objects, such as user hand 200, are observable within a view field VF.

As illustrated, in some embodiments, the light view angle VA (e.g., 30-120 degrees) can be substantially larger than the light projection angle PA (e.g., 15-50 degrees). For wide-angle gesture detection, the viewing sensor 148 may have a view angle VA of at least 50 degrees, or for extra wide-angle, view angle VA may be at least 90 degrees. For example, viewing sensor 148 may include a wide-angle camera lens (e.g., fish-eye lens).

### Method for Viewing Hand Gestures

Turning now to FIG. 6, a flowchart is presented of a computer implemented method for capturing light views of hand gestures. The method may be implemented in the view grabber 118 and executed by the pointer control unit 108 (FIG. 1). The method may be invoked by a high-level method (e.g., step S103 of FIG. 4).

So beginning with steps S120-S121, a first light view is captured.

That is, in step S120, pointer control unit 108 may enable the viewing sensor 148 to capture light for a predetermined time period (e.g., 0.01 second). For example, if the viewing sensor is an image sensor, an electronic shutter may be briefly opened. Wherein, the viewing sensor 148 may capture an ambient light view (or “photo” image frame) of its field of view forward of the pointer 100.

Then in step S121, control unit 108 and view grabber 118 may take receipt of and store the ambient light view in captured view data 104 for future analysis. In addition, control unit 108 may create and store a view definition (e.g., View Type=AMBIENT, Timestamp=12:00:00 AM, etc.) to accompany the light view.

Turning to steps S122-S125, a second light view is captured.

That is, in step S122, the control unit 108 may activate illumination from the gesture projector 128 forward of the pointer 100.

Then in step S123, control unit 108 may again enable the viewing sensor for a predetermined period (e.g., 0.01 second) to capture a lit light view.

Then in step S124, control unit 108 and view grabber 118 may take receipt of and store the lit light view in captured view data 104 for future analysis. In addition, control unit 108 may create and store a view definition (e.g., View Type=LIT, Timestamp=12:00:01 AM, etc.) to accompany the lit light view.

Then in step S125, the control unit 108 may deactivate illumination from the gesture projector 128, such that substantially no light is projected.

Continuing step S126, a third light view is computed. That is, control unit 108 and view grabber 118 may retrieve the previously stored ambient and lit light views and compute image subtraction of the ambient and lit light views, resulting in a gesture light view. Image subtraction techniques may be adapted from current art. Whereby, the control unit 108 and view grabber 118 may take receipt of and store the gesture light view in captured view data 104 for future analysis. The control unit 108 may further create and store a view definition (e.g., View Type=GESTURE, Timestamp=12:00:02 AM, etc.) to accompany the gesture light view.

Alternative method embodiments may be considered, depending on design objectives. Though the current method captures three light views at each invocation, some alternate methods may capture one or more light views. In some embodiments, if the viewing sensor is a 3-D camera, an alternate method may capture a 3D light view or 3D depth view. In certain embodiments, if viewing sensor is comprised of a plurality of light sensors, an alternate method may combine the light sensor views to form a composite light view.

### Method for Hand Gesture Analysis

Turning now to FIG. 7, a flow chart of a computer implemented, hand gesture analysis method is presented, although alternative methods may be considered. The method may be implemented in the gesture analyzer (e.g., gesture analyzer 122) and executed by the pointer control unit 108 (FIG. 1). The method may be invoked by a high-level method (e.g., FIG. 4, step S105).

Beginning with step S130, pointer control unit 108 and gesture analyzer 122 can access at least one light view (e.g., gesture light views from step S126 of FIG. 6) in view data 104 and use computer vision analysis adapted from current art. In some embodiments, analyzer 122 may scan and segment the light view(s) into objects or blob regions (e.g., of a user hand or hands) by discerning variation in brightness and/or color. In other embodiments, gesture analyzer 122 may analyze a 3D spatial depth map comprised of 3D objects (e.g., of a user hand or hands) derived from the light view(s).

In step S134, pointer control unit 108 and gesture analyzer 122 can make object detection and tracking analysis of the light view(s). This may be completed by computer vision (e.g., hand identification and tracking) techniques adapted from current art, where the analyzer searches for temporal and spatial points of interest within the light view(s). For example, the temporal and spatial points of interest may be matched against a data library of predetermined hand shape definitions, as depicted by step S135. As spatial points of interest appear in a sequence of captured light views, the analyzer may further record the objects' identities (e.g., user hand or a plurality of user hands), geometry, position, and/or velocity as tracking data 106.

Continuing to step S136, pointer control unit 108 and gesture analyzer 122 can make gesture analysis of the previously recorded object tracking data 106. That is, gesture analyzer 122 may take the recorded object tracking data 106 and search for a match in a library of predetermined hand gesture definitions (e.g., thumbs up, hand wave, two-handed gestures), as indicated by step S138. This may be completed by gesture matching and detection techniques (e.g., hidden Markov model, neural network, and/or finite state machine) adapted from current art.

Then in step S140, if pointer control unit 108 and gesture analyzer 122 can detect a hand gesture was made, continue to step S142. Otherwise, the method ends.

Finally, in step S142, pointer control unit 108 and gesture analyzer 122 can create a gesture data event (e.g., Event Type=WAVE GESTURE, Gesture Type=MOVING CURSOR, Gesture Position=[10,10,20], etc.) and transmit the data event to the pointer data controller 110, which transmits the data event via the data interface 111 to host appliance 50 (FIG. 1). Wherein, the host appliance 50 can generate multimedia effects (e.g., modify a display image) based upon the received gesture data event (e.g., type of hand gesture and position of hand gesture).

### Example Gesture Data Event

FIG. 8B presents a data table of an example gesture data event D200, which includes gesture related information. Gesture data event D200 may be stored in event data (FIG. 1, reference numeral 107). Gesture data event D200 can include data attributes, such as, but not limited to, an event type D201, a pointer ID D202, an appliance ID D203, a gesture type D204, a gesture timestamp D205, a gesture position D206, a gesture orientation D207, gesture graphic D208, and gesture resource D209.

Event type D201 can identify the type of event (e.g., Event Type=GESTURE) as gesture-specific.

Pointer id D202 can uniquely identify a spatially aware pointer (e.g., Pointer Id=“100”) associated with this event.

Appliance id D203 can uniquely identify a host appliance (e.g., Appliance Id=“50”) associated with this event.

Gesture type D204 can identify the type of hand gesture being made (e.g., Gesture Type=LEFT HAND POINTING, TWO HANDED WAVE, THUMBS UP GESTURE, TOUCH GESTURE, etc.).

Gesture timestamp D205 may designate time of day (e.g., Gesture Timestamp=6:30:00 AM) for coordinating events by time.

Gesture position D206 can define the spatial position of the gesture (e.g., Gesture Position=[20, 20, 0] when hand is in top/right quadrant) within the field of view.

Gesture orientation D207 can define the spatial orientation of the gesture (e.g., Gesture Orientation=[0 degrees, 0 degrees, 180 degrees] when hand is pointing leftward) within the field of view.

Gesture graphic D208 can define the filename (or file locator) of an appliance graphic element (e.g., graphic file) associated with this gesture.

Gesture content D208 can include any type of multimedia content (e.g., graphics data, audio data, universal resource locator (URL) data, etc.) associated with this event.

### Detecting a Touch Gesture on Remote Surface

FIGS. 9A-9C show perspective views of the pointer 100 and appliance 50, where the image projector 52 is illuminating a projected image 220 on a remote surface 224, such as, for example, a wall or tabletop. Specifically in the visible light spectrum in FIG. 9A, the visible projected image 220 is comprised of an interactive graphic element 212.

Then in the infrared light spectrum in FIG. 9B, the pointer 100 and its viewing sensor 148 can observe and track the movement of a user hand 200. In an example operation, pointer 100 can activate infrared light from the gesture projector 128, which illuminates the user hand 200 (not touching the surface 224), which creates a light shadow 204 to fall on the remote surface 224.

Then in the infrared spectrum of FIG. 9C, the pointer 100 and its viewing sensor 148 can observe and track the movement of the user hand 200, where the hand 200 (touches the remote surface 224 at touch point TP1). Whereby, in an example operation, pointer 100 may activate infrared light from the gesture projector 128, which illuminates the user hand 200, and light shadow 204 is created by hand 200. The shadow 204 further tapers to a sharp corner at touch point TP1 where the user hand 200 has touched the remote surface 224.

Whereby, the pointer 100 can enable its viewing sensor 148 to capture at least one light view and analyze the light view(s) for the tapering light shadow 204 that corresponds to the user hand 200 touching the remote surface 224 at touch point TP1. If a hand touch has occurred, the pointer can then create a touch gesture data event (e.g., Gesture Type=FINGER TOUCH, Gesture Position=[20,30,12]) based upon a user hand touching a remote surface. Pointer 100 can then transmit the touch gesture data event to appliance 50.

Whereby, the appliance 50 may generate multimedia effects (e.g., modify a display image) based upon the received touch gesture data event. For example, appliance 50 may modify the projected image 220 such that the graphic element 212 (in FIG. 9A) reads “Prices”.

### Method for Touch Gesture Analysis

Turning now to FIG. 10, a flow chart of a computer implemented, touch gesture analysis method is presented, although alternative methods may be considered. The method may be implemented in the gesture analyzer 122 and executed by the pointer control unit 108 (FIG. 1). This method may be invoked by a high-level method (e.g., step S105 of FIG. 4).

Beginning with step S150, the pointer control unit 108 and gesture analyzer 122 can access at least one light view (e.g., gesture light views from step S126 of FIG. 6) from view data 104 and use computer vision techniques adapted from current art. In some embodiments, analyzer 122 may scan and segment the light view(s) into objects or blob regions (e.g., of a user hand or hands and background) by discerning variation in brightness and/or color. In other embodiments, gesture analyzer 122 may analyze a 3D spatial model (e.g., from a 3D depth camera) comprised of remote objects (e.g., of a user hand or hands) derived from the light view(s).

In step S154, pointer control unit 108 and gesture analyzer 122 can make object detection and tracking analysis of the light view(s). This may be completed by computer vision (e.g., hand identification and tracking) techniques adapted from current art, where the analyzer searches for temporal and spatial points of interest within the light view(s). For example, the temporal and spatial points of interest may be matched against a data library of predetermined hand shape definitions, as depicted by step S155. As spatial points of interest appear in a sequence of captured light views, the analyzer may further record the objects' identities (e.g., user hand or a plurality of user hands), geometry, position, and/or velocity as tracking data 106.

Continuing to step S156, pointer control unit 108 and gesture analyzer 122 can make touch gesture analysis of the previously recorded object tracking data 106. That is, the gesture analyzer may take the recorded object tracking movements and search for a match in a library of predetermined hand touch gesture definitions (e.g., tip or finger of hand touches a surface), as indicated by step S158. This may be completed by gesture matching and detection techniques (e.g., hidden Markov model, neural network, and/or finite state machine) adapted from current art.

Then in step S160, if pointer control unit 108 and gesture analyzer 122 can detect that a hand touch gesture was made, continue to step S162. Otherwise, the method ends.

Finally, in step S162, pointer control unit 108 and gesture analyzer 122 can create a touch gesture data event (e.g., Gesture Type=FINGER TOUCH, Gesture Position=[20,30,12], etc.) and transmit the event to the pointer data controller 110, which transmits the event via the data interface 111 to host appliance 50 (FIG. 1). Whereby, the host appliance 50 can generate multimedia effects based upon the received touch gesture data event and/or the spatial position of touch hand gesture.

### Calibrate Workspace on Remote Surface

FIG. 11 shows a perspective view of a user calibrating a workspace on a remote surface. Appliance 50 and projector 52 are illuminating projected image 220 on remote surface 224, such as, for example, a wall, floor, and/or tabletop. Moreover, pointer 100 has been operatively coupled to appliance 50, thereby, enabling appliance 50 with touch gesture control of projected image 220.

In an example calibration operation, a user (not shown) may move hand 200 and touch graphic element 212 located at corner of image 220. Whereupon, pointer 100 may detect a touch gesture at touch point A2 within a view region 420 of the pointer's viewing sensor 148. User may then move hand 200 and touch image 220 at points A1, A3, and A4. Whereupon, four touch gesture data events may be generated that define four touch points A1, A2, A3, and A4 that coincide with four corners of image 220.

Pointer 100 may now calibrate the workspace by creating a geometric mapping between the coordinate systems of the view region 420 and projection region 222. This may enable the view region 420 and projection region 222 to share the same spatial coordinates. Moreover, the display resolution and projector throw angles (as shown earlier in FIG. 3B) may be utilized to rescale view coordinates into display coordinates, and visa versa. Geometric mapping (e.g., coordinate transformation matrices) may be adapted from current art.

### Shared Workspace on Remote Surface

FIG. 12 shows a perspective view of a shared workspace on a remote surface. As depicted, first spatially aware pointer 100 has been operatively coupled to first host appliance 50, while a second spatially aware pointer 101 has been operatively coupled to a second host appliance 51. The second pointer 101 may be constructed and function similarly to first pointer 100 (in FIG. 1), while the second appliance 51 may be constructed and function similarly to the first appliance 50 (in FIG. 1).

Wherein, appliance 50 includes image projector 52 having projected image 220 in projection region 222, while appliance 51 includes image projector 53 having projected image 221 in projection region 223. The projection regions 222 and 223 form a shared workspace on remote surface 224. As depicted, graphic element 212 is currently located in projection region 222. Graphic element 212 may be similar to a “graphic icon” used in many graphical operating systems, where element 212 may be associated with appliance resource data (e.g., video, graphic, music, uniform resource locator (URL), program, multimedia, and/or data file).

In an example operation, a user (not shown) may move hand 200 and touch graphic element 212 on surface 224. Hand 200 may then be dragged across projection region 222 along move path M3 (as denoted by arrow) into projection region 223. During which time, graphic element 212 may appear to be graphically dragged along with the hand 200. Whereupon, the hand (as denoted by reference numeral 200′) is lifted from surface 224, depositing the graphic element (as denoted by reference numeral 212′) in projection region 223.

In some embodiments, a shared workspace may enable a plurality of users to share graphic elements and resource data among a plurality of appliances.

### Method for Shared Workspace

Turning to FIG. 13, a sequence diagram is presented of a computer implemented, shared workspace method between first pointer 100 operatively coupled to first appliance 50, and second pointer 101 operatively coupled to second appliance 51. The operations for pointer 100 (FIG. 1) may be implemented in pointer program 114 and executed by the pointer control unit 108 (and correspondingly similar for pointer 101). Operations for appliance 50 (FIG. 1) may be implemented in host program 56 and executed by host control unit 54 (and correspondingly similar for appliance 51).

Start-Up:

Beginning with step S170, first pointer 100 (and its host appliance 50) and second pointer 101 (and its host appliance 51) may create a data communication link with each other by utilizing the appliances' wireless transceivers (e.g., FIG. 1, reference numeral 55). Wherein, the pointers 100 and 101 and respective appliances 50 and 51 may configure and exchange data settings. For example, pointer data settings (as shown earlier in FIG. 3B) may be shared.

In step S172, the pointers 100 and 101 (and appliances 50 and 51) may create a shared workspace. For example, a user may indicate to pointers 100 and 101 that a shared workspace is desired, such as, but not limited to: 1) by making a plurality of touch gestures on the shared workspace; 2) by selecting a “shared workspace” mode in host user interface; and/or 3) by placing pointers 100 and 101 substantially near each other.

First Phase:

Then in step S174, first pointer 100 may detect a drag gesture being made on a graphic element within its projection region. Pointer 100 may create a first drag gesture data event (e.g., Gesture Type=DRAG, Gesture Position=[20,30,12], Gesture Graphic=“Duck” graphic file, Gesture Resource=“Quacking” music file) that specifies the graphic element and its associated resource data.

Continuing to step S175, first pointer 100 may transmit the drag gesture data event to first appliance 50, which transmits event to second appliance 51 (as shown in step S176), which transmits event to second pointer 101 (as shown in step S177).

Second Phase:

Then in step S178, second pointer 101 may detect a drag gesture being made concurrently within its projection region. Pointer 101 may create a second drag gesture data event (e.g., Gesture Type=DRAG, Gesture Position=[20,30,12], Gesture Graphic=Unknown. Gesture Resource=Unknown) that is not related to a graphic element or resource data.

Whereupon, in step S179, second pointer 101 may try to associate the first and second drag gestures as a shared gesture. For example, pointer 101 may associate the first and second drag gestures if gestures occur at substantially the same location and time on the shared workspace.

If the first and second gestures are associated, then pointer 101 may create a shared gesture data event (e.g., Gesture Type=SHARED GESTURE, Gesture Position=[20,30,12], Gesture Graphic=“Duck” graphic file, Gesture Resource=“Quacking” music file).

In step S180, pointer 101 transmits the event to appliance 51, which transmits event to appliance 50, shown in step S181.

Third Phase:

Finally, in step S182, first appliance 50 may take receipt of the shared gesture data event and parses its description. In response, appliance 50 may retrieve the described graphic element (e.g., “Duck” graphic file) and resource data (e.g. “Quacking” music file) from its memory storage. First appliance 50 may transmit the graphic element and resource data to second appliance 51. Wherein, second appliance 51 may take receipt of and store the graphic element and resource data in its memory storage.

Then in step S184, first appliance 50 may generate multimedia effects based upon the received shared gesture data event from its operatively coupled pointer 100. For example, first appliance 50 may modify its projected image. As shown in FIG. 12, first appliance 50 may modify first projected image 220 to indicate removal of graphic element 212 from projection region 222.

Then in step S186 of FIG. 13, second appliance 51 may generate multimedia effects based upon the shared gesture data event from its operatively coupled pointer 101. For example, as best seen in FIG. 12, second appliance 51 may modify second projected image 221 to indicate the appearance of graphic element 212′ on projection region 223.

In some embodiments, the shared workspace may allow one or more graphic elements 112 to span and be moved seamlessly between projection regions 222 and 223. Certain embodiments may clip away a projected image to avoid unsightly overlap with another projected image, such as a clipping away polygon region defined by points B1, A2, A3, and B4. Image clipping techniques may be adapted from current art.

In some embodiments, there may be a plurality of appliances (e.g., more than two) that form a shared workspace. In some embodiments, alternative types of graphic elements and resource data may be moved across the workspace, enabling graphic elements and resource data to be copied or transferred among a plurality of appliances.

### Example Embodiments of a Pointer Indicator

Turning to FIG. 14, a perspective view is shown of pointer 100 and appliance 50 located near a remote surface 224, such as, for example, a wall or floor. As illustrated, the pointer 100 and indicator projector 124 can project a light beam LB that illuminates a pointer indicator 296 on surface 224. The indicator 296 can be comprised of one or more optical fiducial markers in Cartesian space and may be used for, but not limited to, spatial position sensing by pointer 100 and other pointers (not shown) in the vicinity. In the current embodiment, pointer indicator 296 is a predetermined pattern of light that can be sensed by viewing sensor 148 and other pointers (not shown).

In some embodiments, a pointer indicator can be comprised of a pattern or shape of light that is asymmetrical and/or has one-fold rotational symmetry. The term “one-fold rotational symmetry” denotes a shape or pattern that only appears the same when rotated a fill 360 degrees. For example, a “U” shape (similar to indicator 296) has a one-fold rotational symmetry since it must be rotated a full 360 degrees on its view plane before it appears the same. Such a feature enables pointer 100 or another pointer to optically discern the orientation of the pointer indicator 296 on the remote surface 224. For example, pointer 100 or another pointer (not shown) can use computer vision to determine the orientation of an imaginary vector, referred to as an indicator orientation vector IV, that corresponds to the orientation of indicator 296 on the remote surface 224. In certain embodiments, a pointer indicator may be asymmetrical along at least one axis and/or have a one-fold rotational symmetry, such that a pointer orientation RZ (e.g., rotation on the Z-axis) of the pointer 100 can be optically determined by another pointer.

In some embodiments, a pointer indicator (e.g., indicator 332 of FIG. 15) can be substantially symmetrical and/or have multi-fold rotational symmetry. Whereby, the pointer 100 and host appliance 50 may utilize one or more spatial sensors (not shown) to augment or determine the pointer orientation RZ. The one or more spatial sensors can be comprised of, but not limited to, a magnetometer, accelerometer, gyroscope, and/or a global positioning system device.

In some embodiments, a pointer indicator (e.g., indicators 333 and 334 of FIG. 15) can be comprised of at least one 1D-barcode, 2D-barcode, and/or optically machine readable pattern that represents data, such that, for example, a plurality of spatially aware pointers can communicate information using light.

So turning to FIG. 15, example embodiments of pointer indicators are presented, which include “V”-shaped indicator 330 having one-fold rotational symmetry; “T”-shaped indicator 331 with one-fold rotational symmetry; square indicator 332 with four-fold rotational symmetry; 1D-barcode indicator 333 comprised of an optically machine readable pattern that represents data; and 2D-barcode indicator 334 comprised of an optically machine readable pattern that represents data. Understandably, alternate shapes and/or patterns may be utilized as a pointer indicator.

### Example of Illuminating a Plurality of Pointer Indicators

Turning to FIG. 16, there presented is a pointer 98 that can illuminate a plurality of pointer indicators for spatial sensing operations. In an example operation, pointer 98 illuminates a first pointer indicator 335-1 (of an optically machine readable pattern that represents data), and subsequently after a brief period of time, pointer 98 illuminates a second pointer indicator 335-2 (of a spatial sensing pattern). Thus, in certain embodiments, a pointer can illuminate a plurality of pointer indicators that have a unique pattern and/or shape, as illustrated.

### Example Embodiments of an Indicator Projector

Turning to FIGS. 17A-17C, presented are detailed views of the indicator projector 124 utilized by the pointer 100 (e.g., FIGS. 1 and 14). FIG. 17A shows a perspective view of the indicator projector 124 that projects a light beam LB from body 302 (e.g., 5 mm W×5 mm H×15 mm D) and can illuminate a pointer indicator (e.g., indicator 296 in FIG. 14). FIG. 17C shows a section view of the indicator projector 124 comprised of, but not limited to, a light source 316, an optical medium 304, and an optical element 312.

The light source 316 may be comprised of at least one light-emitting diode (LED) and/or laser device (e.g., laser diode) that generates at least infrared light, although other types of light sources, numbers of light sources, and/or types of generated light (e.g., invisible or visible, coherent or incoherent) may be utilized.

The optical element 312 may be comprised of any type of optically transmitting medium, such as, for example, a light refractive optical element, light diffractive optical element, and/or a transparent non-refracting cover. In some embodiments, optical element 312 and optical medium 304 may be integrated.

In at least one embodiment, indicator projector 124 may operate by filtered light. FIG. 17B shows a top view of optical medium 304 comprised of substrate (e.g., clear plastic) with an indicia of light transmissive region 307 and light attenuating region 307 (e.g., printed ink/dye or embossing). Then in operation in FIG. 17C, light source 316 can emit light filtered by optical medium 304, and transmitted by optical element 310.

In an alternate embodiment, indicator projector 124 may operate by diffracting light. FIG. 17B shows a top view of the optical medium 304 comprised of light diffractive substrate (e.g., holographic optical element, diffraction grating, etc.). Then in operation in FIG. 17C, light source 316 may emit coherent light diffracted by optical medium 304, and transmitted by optical element 310.

In another alternate embodiment, FIG. 18 presents an indicator projector 320 comprised of body 322 having a plurality of light sources 324 that can create light beam LB to illuminate a pointer indicator (e.g., indicator 296 of FIG. 14).

In yet another alternate embodiment, FIG. 19 presents an indicator projector 318 comprised of a Laser-, a Liquid Crystal on Silicon (LCOS)-, or Digital Light Processor (DLP)-based image projector that can create light beam LB to illuminate one or more pointer indicators (e.g., indicator 296 of FIG. 14), although an alternative type of image projector can be utilized as well.

### General Method of Spatial Sensing for a Plurality of Pointers

A plurality of spatially aware pointers may provide spatial sensing capabilities for a plurality of host appliances. So turning ahead to FIGS. 21A-22B, a collection of perspective views show first pointer 100 has been operatively coupled to first host appliance 50, while second pointer 101 has been operatively coupled to second host appliance 51. Second appliance 51 may be constructed similar to first appliance 50 (FIG. 1). Wherein, appliances 50 and 51 may each include a wireless transceiver (FIG. 1, reference numeral 55) for remote data communication. As can be seen, appliances 50 and 51 have been located near remote surface 224, such as, for example, a wall or tabletop.

Turning back to FIG. 20, a sequence diagram presents a computer implemented, sensing method, showing the setup and operation of pointers 100 and 101 and their respective appliances 50 and 51. The operations for pointer 100 (FIG. 1) may be implemented in pointer program 114 and executed by the pointer control unit 108 (and correspondingly similar for pointer 101). Operations for appliance 50 (FIG. 1) may be implemented in host program 56 and executed by host control unit 54 (and correspondingly similar for appliance 51).

Start-Up:

Beginning with step S300, first pointer 100 (and first appliance 50) and second pointer 101 (and second appliance 51) can create a data communication link with each other by utilizing the appliances' wireless transceivers (e.g., FIG. 1, reference numeral 55). In step S302, pointers 100 and 101 and respective appliances 50 and 51 may configure and exchange data settings for indicator sensing. For example, pointer data settings (e.g., in FIG. 3B) may be shared.

First Phase:

Continuing with FIG. 20 at step S306, pointers 100 and 101, along with their respective appliances 50 and 51, begin a first phase of operation.

To start, first pointer 100 can illuminate a first pointer indicator on one or more remote surfaces (e.g., as FIG. 21A shows indicator projector 124 illuminating a pointer indicator 296 on remote surface 224).

Then in step S310, first pointer 100 can create and transmit an active pointer data event (e.g., Event Type=ACTIVE POINTER, Appliance Id=50, Pointer Id=100, Image_Content, etc.) to first appliance 50, informing other spatially aware pointers in the vicinity that a pointer indicator is illuminated.

Whereby, in step S311, first appliance 50 transmits the active pointer data event to second appliance 51, which in step S312 transmits event to second pointer 101.

At step S314, the first pointer 100 can enable viewing of the first pointer indicator. That is, first pointer 100 may enable its viewing sensor, capture one or more light views, and detect at least a portion of the first pointer indicator within the light view(s) (e.g., as FIG. 21A shows pointer 100 enable viewing sensor 148 to capture a view region 420 of the indicator 296).

At step S315, first pointer 100 can compute spatial information related to one or more remote surfaces (e.g., as FIG. 21A shows surface distance SD1) and create and transmit a detect pointer data event (e.g., Event Type=DETECT POINTER, Surface Position=[10,20,10] units, Surface Orientation=[5,10,15] degrees, Surface Distance=10 units, etc.) to the first appliance 50.

At step S316 (which may be substantially concurrent with step S314), the second pointer 101 can receive the active pointer data event (from step S311) and enable viewing. That is, second pointer 101 can enable its viewing sensor, capture one or more light views, and detect at least a portion of the first pointer indicator within the light view(s) (e.g., FIG. 21B shows second pointer 101 enable viewing sensor 149 to capture a view region 421 of the indicator 296). Second pointer 101 can compute spatial information related to the first pointer indicator and first pointer (e.g., as FIG. 21B shows indicator position IP and pointer position PP1) and create a detect pointer data event (e.g., Event Type=DETECT POINTER, Pointer Id=100, Appliance Id=50, Pointer Position=[5,10,20], Pointer Orientation=[0,0,−10] degrees, Indicator Position=[10,15,10] units, Indicator Orientation=[0,0,10] degrees, etc.). The pointer 101 may also complete internal operations based upon the detect pointer data event, such as, for example, calibration of pointer 101.

Then in step S319, second pointer 101 can transmit the detect pointer data event to second appliance 51.

In step S320, second appliance 51 can receive the detect pointer data event and operate based upon the detect pointer event. For example, second appliance 51 may generate multimedia effects based upon the detect pointer data event, where appliance 51 generates a graphic effect (e.g., modify projected image), sound effect (e.g., play music), and/or haptic effect (e.g., enable vibration).

Second Phase:

Continuing with FIG. 20 at step S322, pointers 100 and 101, along with their respective appliances 50 and 51, begin a second phase of operation.

To start, second pointer 101 can illuminate a second pointer indicator on one or more remote surfaces (e.g., as FIG. 22A shows indicator projector 125 illuminate pointer indicator 297 on remote surface 224).

Then in step S324, second pointer 101 can create and transmit an active pointer data event (e.g., Event Type=ACTIVE POINTER, Appliance Id=51, Pointer Id=101, Image Content, etc.) to second appliance 51, informing other spatially aware pointers in the vicinity that a second pointer indicator is illuminated.

Whereby, in step S325, second appliance 51 can transmit the active pointer data event to first appliance 50, which in step S326 transmits the event to the first pointer 100.

At step S330, the second pointer 101 can enable viewing of the second pointer indicator. That is, second pointer 101 can enable its viewing sensor, capture one or more light views, and detect at least a portion of the second pointer indicator within light view(s) (e.g., as FIG. 22A shows second pointer 101 and viewing sensor 149 capture a view region 421 of the indicator 297).

At step S324, second pointer 101 can also compute spatial infomnnation related to one or more remote surfaces (e.g., as FIG. 22A shows surface distance SD2) and create and transmit a detect pointer data event (e.g., Event Type=DETECT POINTER, Surface Position=[11,21,11] units, Surface Orientation=[6,11,16] degrees, Surface Distance=11 units, etc.) to the second appliance 51.

At step S328 (which may be substantially concurrent with step S330), the first pointer 100 can receive the active pointer data event (from step S325) and enable viewing. That is, first pointer 100 can enable its viewing sensor, capture one or more light views, and detect at least a portion of the second pointer indicator within the light view(s) (e.g., as FIG. 22B shows first pointer 100 capture the view region 420 of indicator 297). First pointer 100 can then compute spatial information related to the second pointer indicator and second pointer (e.g., as FIG. 22B shows indicator position IP and pointer position PP2) and create a detect pointer data event (e.g., Event Type=DETECT POINTER, Appliance Id=51, Pointer Id=101, Pointer Position=[5,10,20], Pointer Orientation=[0,0,0,10] degrees, Indicator Position=[10,15,10] units, Indicator Orientation=[0,0,10] degrees, etc.). First pointer 100 may also complete internal operations based upon the detect pointer data event, such as, for example, calibration of pointer 100.

Then in step S332, first pointer 100 can transmit the detect pointer data event to first appliance 50.

In step S334, first appliance 50 can receive the detect pointer data event and operate based upon the detect pointer event. For example, first appliance 50 may generate multimedia effects based upon the detect pointer data event, where appliance 50 generates a graphic effect (e.g., modify projected image), sound effect (e.g., play music), and/or haptic effect (e.g., enable vibration).

Finally, the pointers and host appliances can continue spatial sensing. That is, steps S306-S334 can be continually repeated so that both pointers 100 and 101 may inform their respective appliances 50 and 51 with, but not limited to, spatial position information. Pointers 100 and 101 and respective appliances 50 and 51 remain spatially aware of each other. In some embodiments, the position sensing method may be readily adapted for operation of three or more spatially aware pointers. In some embodiments, pointers that do not sense their own pointer indicators may not require steps S314-S315 and S330-S331.

In certain embodiments, pointers may rely on various sensing techniques, such as, but not limited to:

1) Each spatially aware pointer can generate a pointer indicator in a substantially mutually exclusive temporal pattern; wherein, when one spatially aware pointer is illuminating a pointer indicator, all other spatially aware pointers have substantially reduced illumination of their pointer indicators (e.g., as described in FIGS. 20-24).

2) Each spatially aware pointer can generate a pointer indicator using modulated light having a unique modulation duty cycle and/or frequency (e.g., 10 kHz, 20 kHz, etc.); wherein, each spatially aware pointer can optically detect and differentiate each pointer indicator.

3) Each spatially aware pointer can generate a pointer indicator having a unique shape or pattern; wherein, each spatially aware pointer can optically detect and differentiate each pointer indicator. For example, each spatially aware pointer may generate a pointer indicator comprised of at least one unique 1D-barcode, 2D-barcode, and/or optically machine readable pattern that represents data.

### Example of Spatial Sensing for a Plurality of Pointers

First Phase:

Turning to FIG. 21A, a perspective view shows pointers 100 and 101 and appliances 50 and 51, respectively. In an example first phase of operation, first pointer 100 can enable indicator projector 124 to illuminate a first pointer indicator 296 on remote surface 224.

During which time, first pointer 100 can enable viewing sensor 148 to observe view region 420 including first indicator 296. Pointer 100 and its view grabber 118 (FIG. 1) may then capture at least one light view that encompasses view region 420. Whereupon, pointer 100 and its indicator analyzer 121 (FIG. 1) may analyze the captured light view(s) and detect at least a portion of first indicator 296. First pointer 100 may designate its own Cartesian space X-Y-Z or spatial coordinate system. Whereby, indicator analyzer 121 (FIG. 1) may compute indicator metrics (e.g., illumination position, orientation, etc.) of indicator 296 and computationally transform the indicator metrics into spatial information related to one or more remote surfaces, such as, but not limited to, a surface distance SD1, and a surface point SP1. For example, a spatial distance between pointer 100 and remote surface 224 may be determined using triangulation or time-of-flight light analysis of indicator 296 appearing in at least one light view of viewing sensor 148.

Then in FIG. 21B, a perspective view shows pointers 100 and 101 and appliances 50 and 51, where first pointer 100 has enabled the indicator projector 124 to illuminate first pointer indicator 296 on remote surface 224. During which time, second pointer 101 can enable viewing sensor 149 to observe view region 421 that includes first indicator 296. Second pointer 101 and its view grabber may capture at least one light view that encompasses view region 421. Whereupon, second pointer 101 and its indicator analyzer may analyze the captured light view(s) and detect at least a portion of first pointer indicator 296. Second pointer 101 may designate its own Cartesian space X′-Y′-Z′ or spatial coordinate system. Wherein, second pointer 101 and its indicator analyzer may further compute indicator metrics (e.g., illumination position, orientation, etc.) of indicator 296 and computationally transform the indicator metrics into spatial information related to the first pointer indicator 296 and first pointer 100.

The spatial information may be comprised of, but not limited to, an orientation vector IV (e.g., [−20] degrees), an indicator position IP (e.g., [−10, 20, 10] units), indicator orientation IR (e.g., [0,0,−20] degrees), indicator width IW (e.g., 5 units), indicator height IH (e.g., 3 units), pointer position PP1 (e.g., [10,−20,20] units), pointer distance PD1 (e.g., [25 units]), and pointer orientation RX, RY and RZ (e.g., [0,0,−20] degrees), as depicted in FIG. 21C (where appliance is not shown). Such computations may rely on computer vision functions (e.g., projective geometry, triangulation, parallax, homography, and/or camera pose estimation) adapted from current art.

Second Phase:

Turning now to FIG. 22A, a perspective view shows pointers 100 and 101 and appliances 50 and 51. In an example second phase of operation, second pointer 101 can enable indicator projector 125 to illuminate a second pointer indicator 297 on remote surface 224.

During which time, second pointer 101 can enable its viewing sensor 149 to observe view region 421 including second indicator 296. Pointer 101 and its view grabber may then capture at least one light view that encompasses view region 421. Whereupon, pointer 101 and its indicator analyzer may analyze the captured light view(s) and detect at least a portion of second pointer indicator 297. Second pointer 101 may designate its own Cartesian space X′-Y′-Z′. Whereby, indicator analyzer may compute indicator metrics (e.g., illumination position, orientation, etc.) of indicator 297 and computationally transform the indicator metrics into spatial information related to one or more remote surfaces, such as, but not limited to, a surface distance SD2, and a surface point SP2. For example, a spatial distance between pointer 101 and remote surface 224 may be determined using triangulation or time-of-flight light analysis of indicator 297 appearing in at least one light view of viewing sensor 149.

Now turning to FIG. 22B, a perspective view shows pointers 100 and 101 and appliances 50 and 51, where second pointer 101 has enabled indicator projector 125 to illuminate a second pointer indicator 297 on remote surface 224. During which time, first pointer 100 can enable viewing sensor 148 to observe view region 420 that includes second indicator 297. First pointer 100 and its view grabber may capture at least one light view that encompasses view region 420. Whereupon, first pointer 100 and its indicator analyzer may analyze the captured light view(s) and detect at least a portion of pointer indicator 297. First pointer 100 may designate its own Cartesian space X-Y-Z. Wherein, first pointer 100 and its indicator analyzer may further compute indicator metrics (e.g., illumination position, orientation, etc.) of indicator 297 and computationally transform the indicator metrics into spatial information related to the second pointer indicator 297 and second pointer 101.

The spatial information may be comprised of, but not limited to, orientation vector IV (e.g., [25] degrees), indicator position IP (e.g., [20, 20, 10] units), indicator orientation IR (e.g., [0,0,25] degrees), indicator width IW (e.g., 5 units), indicator height IH (e.g., 3 units), pointer position PP1 (e.g., [−20,−10,20] units), pointer distance PD1 (e.g., [23 units]), and pointer orientation (e.g., [0,0,25] degrees). Such computations may rely on computer vision functions (e.g., projective geometry, triangulation, parallax, homography, and/or camera pose estimation) adapted from current art.

In FIGS. 21A-22B, the first and second phases for spatial sensing (as described above) may then be continually repeated so that pointers 100 and 101 remain spatially aware. In some embodiments, a plurality of pointers may not compute pointer positions and pointer orientations. In certain embodiments, a plurality of pointers may computationally average a plurality of sensed indicator positions for improved accuracy. In some embodiments, pointers may not analyze their own pointer indicators, so operations of FIGS. 21A and 22A are not required.

### Method for Illuminating and Viewing a Pointer Indicator

Turning now to FIG. 23, a flow chart of a computer implemented method is presented, which can illuminate at least one pointer indicator and capture at least one light view, although alternative methods may be considered. The method may be implemented in the indicator maker 117 and view grabber 118 and executed by the pointer control unit 108 (FIG. 1). The method may be continually invoked by a high-level method (e.g., step S102 of FIG. 4).

Beginning with step S188, pointer control unit 108 and view grabber 118 may enable the viewing sensor 148 (FIG. 1) to sense light for a predetermined time period (e.g., 0.01 second). Wherein, the viewing sensor 148 can capture an ambient light view (or “photo” snapshot) of its field of view forward of the pointer 100 (FIG. 1). The light view may be comprised of, for example, an image frame of pixels of varying light intensity.

The control unit 108 and view grabber 118 may take receipt of and store the ambient light view in captured view data 104 (FIG. 1) for future analysis. In addition, control unit 108 may create and store a view definition (e.g., View Type=AMBIENT, Timestamp=12:00:00 AM, etc.) to accompany the light view.

In step S189, if pointer control unit 108 and indicator maker 117 detect an activate indicator condition, the method continues to step S190. Otherwise, the method skips to step S192. The activate indicator condition may be based upon, but not limited to: 1) a period of time has elapsed (e.g., 0.05 second) since the previous activate indicator condition occurred; and/or 2) the pointer 100 has received an activate indicator notification from host appliance 50 (FIG. 1).

In step S190, pointer control unit 108 and indicator maker 117 can activate illumination of a pointer indicator (e.g., FIG. 21A, reference numeral 296) on remote surface(s). Activating illumination of the pointer indicator may be accomplished by, but not limited to: 1) activating the indicator projector 124 (FIG. 1): 2) increasing the brightness of the pointer indicator; and/or 3) modifying the image being projected by the indicator projector 124 (FIG. 1).

In step S191, pointer control unit 108 and indicator maker 117 can create an active pointer data event (e.g., Event Type=ACTIVE POINTER, Appliance Id=50, Pointer Id=100) and transmits the event to the pointer data controller 110, which transmits the event via the data interface 111 to host appliance 50 (FIG. 1). Wherein, the host appliance 50 may respond to the active pointer data event.

In step S192, if the pointer control unit 108 detects an indicator view condition, the method continues to step S193 to observe remote surface(s). Otherwise, the method skips to step S196. The indicator view condition may be based upon, but not limited to: 1) an Active Pointer Data Event from another pointer has been detected; 2) an Active Pointer Data Event from the current pointer has been detected; and/or 3) the current pointer 100 has received an indicator view notification from host appliance 50 (FIG. 1).

In step S193, pointer control unit 108 and view grabber 118 can enable the viewing sensor for a predetermined period (e.g., 0.01 second) to capture a lit light view. The control unit 108 and view grabber 118 may take receipt of and store the lit light view in captured view data 104 for future analysis. In addition, control unit may create and store a view definition (e.g., View Type=LIT, Timestamp=12:00:01 AM, etc.) to accompany the lit light view.

In step S194, the pointer control unit 108 and view grabber 118 can retrieve the previously stored ambient and lit light views. Wherein, the control unit 108 may compute image subtraction of both ambient and lit light views, resulting in an indicator light view. Image subtraction techniques may be adapted from current art. Whereupon, the control unit 108 and view grabber 118 may take receipt of and store the indicator light view in captured view data 104 for future analysis. The control unit 108 may further create and store a view definition (e.g., View Type=INDICATOR, Timestamp=12:00:02 AM, etc.) to accompany the indicator light view.

Then in step S196, if the pointer control unit 108 determines that the pointer indicator is currently illuminated and active, the method continues to step S198. Otherwise, the method ends.

Finally, in step S198, the pointer control unit 108 can wait for a predetermined period of time (e.g., 0.02 second). This assures that the illuminated pointer indicator may be sensed, if possible, by another spatially aware pointer. Once the wait time has elapsed, pointer control unit 108 and indicator maker 117 may deactivate illumination of the pointer indicator. Deactivating illumination of the pointer indicator may be accomplished by, but not limited to: 1) deactivating the indicator projector 124; 2) decreasing the brightness of the pointer indicator; and/or 3) modifying the image being projected by the indicator projector124. Whereupon, the method ends.

Alternative methods may be considered, depending on design objectives. For example, in some embodiments, if a pointer is not required to view its own illuminated pointer indicator, an alternate method may view only pointer indicators from other pointers. In some embodiments, if the viewing sensor is a 3-D camera, an alternate method may capture a 3-D depth light view. In some embodiments, if the viewing sensor is comprised of a plurality of light sensors, an alternate method may combine the light sensor views to forn a composite light view.

### Method for Pointer Indicator Analysis

Turning now to FIG. 24, a flow chart is shown of a computer implemented method that analyzes at least one light view for a pointer indicator, although alternative methods may be considered. The method may be implemented in the indicator analyzer 121 and executed by the pointer control unit 108 (shown in FIG. 1). The method may be continually invoked by high-level method (e.g., step S106 of FIG. 4).

Beginning with step S200, pointer control unit 108 and indicator analyzer 121 can access at least one light view (e.g., indicator light view) in view data 104 and conduct computer vision analysis of the light view(s). For example, the analyzer 121 may scan and segment the light view(s) into various blob regions (e.g., illuminated areas and background) by discerning variation in brightness and/or color.

In step S204, pointer control unit 108 and indicator analyzer 121 can do object identification and tracking using the light view(s). This may be completed by computer vision functions (e.g., geometry functions and/or shape analysis) adapted from current art, where analyzer may locate temporal and spatial points of interest within blob regions of the light view(s). Moreover, as blob regions may appear in the captured light view(s), the analyzer may further record the geometry of the blob regions, position and/or velocity as tracking data.

The control unit 108 and indicator analyzer 121 can take the previously recorded tracking data and search for a match in a library of predetermined pointer indicator definitions (e.g., indicator geometries or patterns), as indicated by step S206. To detect a pointer indicator, the control unit 108 and indicator analyzer 121 may use computer vision techniques (e.g., shape analysis and/or pattern matching) adapted from current art.

Then in step S208, if pointer control unit 108 and indicator analyzer 121 can detect at least a portion of a pointer indicator, continue to step S210. Otherwise, the method ends.

In step S210, pointer control unit 108 and indicator analyzer 121 can compute pointer indicator metrics (e.g., pattern height, width, position, orientation, etc.) using light view(s) comprised of at least a portion of the detected pointer indicator.

Continuing to step S212, pointer control unit 108 and indicator analyzer 121 can computationally transform the pointer indicator metrics into spatial information comprising, but not limited to: a pointer position, a pointer orientation, an indicator position, and an indicator orientation (e.g., Pointer Id=100, Pointer Position=[10,10,20] units, Pointer Orientation=[0,0,20] degrees, Indicator Position=[15,20,10] units, Indicator Orientation=[0,0,20] degrees). Such a computation may rely on computer vision functions (e.g., projective geometry, triangulation, homography, and/or camera pose estimation) adapted from current art.

Finally, in step S214, pointer control unit 108 and indicator analyzer 121 can create a detect pointer data event (e.g., comprised of Event Type=DETECT POINTER, Appliance Id=50, Pointer Id=100, Pointer Position=[10,10,20] units, Pointer Orientation=[0,0,20] degrees, Indicator Position=[15,20,10] units, Indicator Orientation=[0,0,20]degrees, etc.) and transmit the event to the pointer data controller 110, which transmits the event via the data interface 111 to host appliance 50 (shown in FIG. 1). Wherein, the host appliance 50 may respond to the detect pointer data event.

### Example of a Pointer Data Event

FIG. 8C presents a data table of an example pointer data event D300, which may include pointer indicator-, andior spatial model-related information. Pointer data event D300 may be stored in event data (FIG. 1, reference numeral 107). Pointer data event D300 may include data attributes such as, but not limited to, an event type D301, a pointer id D302, an appliance id D303, a pointer timestamp D304, a pointer position D305, a pointer orientation D306, an indicator position D308, an indicator orientation D309, and a 3D spatial model D310.

Event type D301 can identify the type of event as pointer related (e.g., Event Type=POINTER).

Pointer id D302 can uniquely identify a spatially aware pointer (e.g., Pointer Id=“100”) associated with this event.

Appliance id D303 can uniquely identify a host appliance (e.g., Appliance Id=“50”) associated with this event.

Pointer timestamp D304 can designate time of event (e.g., Timestamp=6:32:00 AM).

Pointer position D305 can represent a spatial position (e.g., 3-tuple spatial position in 3D space) of a spatially aware pointer in an environment.

Pointer orientation D306 can represent a spatial orientation (e.g., 3-tuple spatial orientation in 3D space) of a spatially aware pointer in an environment.

Indicator position D308 can represent a spatial position (e.g., 3-tuple spatial position in 3D space) of an illuminated pointer indicator on at least one remote surface.

Indicator orientation D309 can represent a spatial orientation (e.g., 3-tuple spatial orientation in 3D space) of an illuminated pointer indicator on at least one remote surface.

The 3D spatial model D310 can be comprised of spatial information that represents, but not limited to, at least a portion of an environment, one or more remote objects, and/or at least one remote surface. In some embodiments, the 3D spatial model D310 may be constructed of geometrical vertices, faces, and edges in a 3D Cartesian space or coordinate system. In certain embodiments, the 3D spatial model can be comprised of one or more 3D object models. Wherein, the 3D spatial model D310 may be comprised of, but not limited to, 3D depth maps, surface distances, surface points, 2D surfaces, 3D meshes, and/or 3D objects, etc. In some embodiments, the 3D spatial model D310 may be comprised of an at least one computer aided design (CAD) data file, 3D model data file, and/or 3D computer graphic data file.

Calibrating a Plurality of Pointers and Appliances (with Projected Images)

FIG. 25 depicts a perspective view of an example of display calibration using two spatially aware pointers, each having a host appliance with a different sized projector display. As shown, first pointer 100 has been operatively coupled to first host appliance 50, while second pointer 101 has been operatively coupled to second host appliance 51. As depicted, appliance 50 includes image projector 52 having projection region 222, while appliance 51 includes image projector 53 having projection region 223.

During display calibration, users (not shown) may locate and orient appliances 50 and 51 such that projectors 52 and 53 are aimed at remote surface 224, such as, for example, a wall or floor. Appliance 50 may project first calibration image 220, while appliance 51 may be project second calibration image 221. As can be seen, images 220 and 221 may be visible graphic shapes or patterns located in predetermined positions in their respective projection regions 222 and 223. Images 220 and 221 may be further scaled by utilizing the projector throw angles (FIG. 3B, reference numeral D56) to assure that images 220 and 221 appear of equal size and proportion. Moreover, for purposes of calibration, images 220 and 221 may be asymmetrical along at least one axis and/or have a one-fold rotational symmetry (e.g., a “V” shape”), although alternative image shapes may be used as well.

To begin calibration in FIG. 25, the images 220 and 221 may act as visual calibrating markers, wherein users (not shown) may move, aim, or rotate the host appliances 50-51 until both images 220-221 appear substantially aligned on surface 224.

Once the images 220-221 are aligned, a user (not shown) can notify appliance 50 with a calibrate input signal initiated by, for example, a hand gesture near appliance 50, or a finger tap to user interface 60.

Appliance 50 can take receipt of the calibrate input signal and create a calibrate pointer data event (e.g., Event Type=CALIBRATE POINTER). Appliance 50 can then transmit data event to pointer 100. In addition, appliance 50 can transmit data event to appliance 51, which transmits event to pointer 101. Wherein, both pointers 100 and 101 have received the calibrate pointer data event and begin calibration.

So briefly turning to FIG. 20, steps S300-S316 can be completed as described. I step S316, pointer 101 can further detect the received calibrate pointer data event (as discussed above) and begin calibration. As best seen in FIG. 25, pointer 101 may form a mapping between the coordinate systems of its view region 421 and projection region 223. This may enable the view region 421 and projection region 223 to share the same spatial coordinates. Geometric mapping (e.g., coordinate transformation matrices) may be adapted from current art.

Then briefly turning again to FIG. 20, steps S319-S328 can be completed as described. In step S328, pointer 100 can further detect the received calibrate pointer data event (as discussed above) and begin calibration. As best seen in FIG. 25, pointer 100 may form a mapping between the coordinate systems of its view region 420 and projection region 222. This enables the view region 420 and projection region 222 to essentially share the same spatial coordinates. Geometric mapping (e.g., coordinate transformation matrices) may be adapted from current art. Whereupon, calibration for pointers 100 and 101 may be assumed complete.

### Computing Position of Projected Images

FIG. 25 shows a perspective of pointers 100 and 101 and appliances 50 and 51 that are spatially aware of their respective projection regions 222 and 223. As presented, appliance 50 with image projector 52 creates projection region 222, and appliance 51 with image projector 53 creates projection region 223. Moreover, projectors 52 and 53 may each create a light beam having a predetermined horizontal throw angle (e.g., 30 degrees) and vertical throw angle (e.g. 20 degrees).

Locations of projection regions 222 and 224 may be computed utilizing, but not limited to, pointer position and orientation (e.g., as acquired by steps S316 and S328 of FIG. 20), and/or projector throw angles (e.g., FIG. 3B, reference numeral D56). Projection region locations may be computed using geometric functions (e.g., trigonometric, projective geometry) adapted from current art.

Wherein, pointer 100 may determine the spatial position of its associated projection region 222 comprised of points A1, A2, A3, and A4. Pointer 101 may determine the spatial position of its associated projection region 223 comprised of points B1, B2, B3, and B4.

### Interactivity of Projected Images

A plurality of spatially aware pointers may provide interactive capabilities for a plurality of host appliances that have projected images. So thereshown in FIG. 26 is a perspective view of first pointer 100 operatively coupled to first host appliance 50, and second pointer 101 operatively coupled to second host appliance 51. As depicted, appliance 50 includes image projector 52 having projection region 222, while appliance 51 includes image projector 53 having projection region 223.

Then in an example operation, users (not shown) may aim appliances 100 and 101 towards remote surface 224, such as a nearby wall, and create visibly illuminated images 220 and 221 on surface 224. First image 220 of a graphic cat is projected by first appliance 50, and second image 221 of a graphic dog is projected by second appliance 51.

As can be seen, the graphic dog is playfully interacting with the graphic cat. The spatially aware pointers 100 and 101 may achieve this feat by exchanging pointer position data with their operatively coupled appliances 50 and 51, respectively. Wherein, appliances 50 and 51 may respond by modifying their respective projected images 220 and 221 of the cat and dog.

To describe the operation, while turning to FIG. 20, the diagram presented earlier describes a method of operation for the interactive pointers 100 and 101, along with their respective appliances 50 and 51. However, there are some additional steps that will be discussed below.

Starting in FIG. 20, steps S300-S310 can be completed as described.

Then in step S311, first appliance 50 can include first image attributes to the received active pointer data event (as shown in step S310), such as, for example:

```
        Event_Type=ACTIVE POINTER.
        Appliance_Id=50.
Pointer_Id=100.
        Image_Content=DOG.
        Image_Name=Rover.
        Image_Pose=Standing and Facing Right.
        Image_Action=Licking.
Image_Location=[0, −2] units.
        Image_Dimension=[10, 20] units.
Image_Orientation=2 degrees.
```

Such attributes define the first image (ofa dog) being projected by first appliance 50. Image attributes may include, but not limited to, description of image content, image dimensions, and/or image location.

Continuing with step S311, first appliance 50 can transmit the active pointer data event to second appliance 51.

Then steps S312-S320 can be completed as described.

In detail, at step S320, second appliance 51 can receive a detect pointer data event (e.g., including first image attributes of a dog) and may generate multimedia effects based upon the received detect pointer data event. For example, second appliance 51 may generate a graphic effect (e.g., modify projected image), sound effect, and/or haptic effect based upon the received detect pointer data event. Second appliance 51 may adjust the position and orientation of its second image (of a cat) on its projected display. Second appliance 51 may animate the second image (of a cat) in response to the action (e.g., Image_Content=DOG, Image_Action=Licking) of the first image. As can be seen in FIG. 26, second appliance 51 and projector 53 may modify the second image 221 such that a grimacing cat is presented. Image rendering techniques (e.g., coordinate transformation matrices) may be adapted from current art.

Then turning again to FIG. 20, steps S322-324 can be completed as described.

Then at step S325, second appliance 51 can add second image attributes to the received active pointer data event (as shown in step S324), such as, for example:

```
        Event_Type=ACTIVE POINTER.
        Appliance_Id=51.
Pointer_Id=101.
        Image_Content=CAT.
        Image_Name=Fuzzy.
        Image_Pose=Sitting and Facing Forward.
        Image_Action=Grimacing.
Image_Location=[1, −1] units.
        Image_Dimension=[8, 16] units.
Image_Orientation=0 degrees.
```

The added attributes define the second image (of a cat) being projected by second appliance 51. Image attributes may include, but not limited to, description of image content, image dimensions, and/or image location.

Continuing with step S324, second appliance 51 can transmit the active pointer data event to first appliance 50.

Then steps S326-S332 can be completed as described.

Therefore, at step S334, first appliance 50 can receive a detect pointer data event (e.g., including image attributes of a cat) and may generate multimedia effects based upon the detect pointer data event. For example, first appliance 50 may generate a graphic effect (e.g., modify projected image), sound effect, and/or haptic effect based upon the received detect pointer data event. First appliance 50 may adjust the position and orientation of its first image (of a dog) on its projected display. First appliance 50 may animate the first image (of a dog) in response to the action (e.g., Image_Content=CAT, Image_Action=Grimacing) of the second image. Using FIG. 26 as a reference, first appliance 50 and projector 52 may modify the first image 220 such that the cowering dog jumps back in fear. Image rendering techniques (e.g., coordinate transformation matrices) may be adapted from current art.

Understandably, the exchange of communication among pointers and appliances, and subsequent multimedia responses can go on indefinitely. For example, after the dog jumps back, the cat may appear to pounce on the dog. Additional play value may be created with other character attributes (e.g., strength, agility, speed, etc.) that may also be communicated to other appliances and spatially aware pointers.

Alternative types of images may be presented by appliances 50 and 51 while remotely controlled by pointers 100 and 101, respectively. Alternative images may include, but not limited to, animated objects, characters, vehicles, menus, cursors, and/or text.

### Combining Projected Images

A plurality of spatially aware pointers may enable a combined image to be created from a plurality of host appliances. So FIG. 27 shows a perspective view of first pointer 100 operatively coupled to first host appliance 50, and second pointer 101 operatively coupled to second host appliance 51. As depicted, appliance 50 includes image projector 52 having projection region 222, while appliance 51 includes image projector 53 having projection region 223.

In an example operation, users (not shown) may aim appliances 100 and 101 towards remote surface 224, such as a nearby wall, and create visibly illuminated images 220 and 221 on surface 224. First image 220 of a castle door is projected by first appliance 50, and second image 221 of a dragon is projected by second appliance 51. The images 220 and 221 may be rendered, for example, from a 3D object model (of castle door and dragon), such that each image represents a unique view or gaze location and direction.

As can be seen, images 220 and 221 may be modified such that at least partially combined image is formed. The pointers 100 and 101 may achieve this feat by exchanging spatial information with their operatively coupled appliances 50 and 51, respectively. Wherein, appliances 50 and 51 may respond by modifying their respective projected images 220 and 221 of the castle door and dragon.

To describe the operation, FIG. 20 shows a method of operation for the interactive pointers 100 and 101, along with their respective appliances 50 and 51. However, there are some additional steps that will be discussed below.

Starting in FIG. 20, steps S300-S310 can be completed as described.

Then in step S311, first appliance 50 can include first image attributes to the received active pointer data event (as shown in step S310), such as, for example:

```
        Event_Type=ACTIVE POINTER.
        Appliance_Id=50.
Pointer_Id=100.
        Image_Gaze_Location=[−10, 0, 0] units, near castle door.
        Image_Gaze_Direction=[0, −10, 5] units, gazing tilted down.
```

The added attributes define the first image (of a door) being projected by first appliance 50. Image attributes may include, but not limited to, description of image gaze location, and/or image gaze direction.

Continuing with step S311, first appliance 50 can transmit the active pointer data event to second appliance 51.

Wherein, steps S312-S319 can be completed as described.

Then at step S320, second appliance 51 can receive a detect pointer data event (e.g., including first image attributes of a door) and may generate multimedia effects based upon the detect pointer data event. For example, appliance 51 may generate a graphic effect (e.g., modify projected image), sound effect, and/or haptic effect based upon the received detect pointer data event. Second appliance 51 may adjust the position and orientation of its second image (of a dragon) on its projected display. As can be seen in FIG. 27, second appliance 51 and projector 53 may modify the second image 221 such an at least partially combined image is formed with the first image 220. Moreover, second appliance 51 and projector 53 may clip image 221 along a clip edge CLP (as denoted by dashed line) such that the second image 221 does not overlap the first image 220. Image rendering and clipping techniques (e.g., polygon clip routines) may be adapted from current art. For example, the clipped-away portion (not shown) of projected image 221 may be rendered with substantially non-illuminated pixels so that it does not appear on surface 224.

Turning again to FIG. 20, steps S322-324 can be completed as described.

Then at step S325, second appliance 51 can add second image attributes to the received active pointer data event (as shown in step S324), such as, for example:

```
        Event_Type=ACTIVE POINTER.
        Appliance_Id=51.
Pointer_Id=101.
        Image_Gaze_Location=[20, 0, 0] units, near dragon.
        Image_Gaze_Direction=[0, 0, 10] units, gazing straight ahead.
```

The added attributes define the second image (of a dragon) being projected by second appliance 51. Image attributes may include, but not limited to, description of image gaze location, and/or image gaze direction.

Continuing with step S324, second appliance 51 can transmit the active pointer data event to first appliance 50.

Then steps S326-S332 can be completed as described.

Whereupon, at step S334, first appliance 50 can receive a detect pointer data event (e.g., including second image attributes of a dragon) and may generate multimedia effects based upon the detect pointer data event. For example, appliance 50 may generate a graphic effect (e.g., modify projected image), sound effect, and/or haptic effect based upon the received detect pointer data event. First appliance 50 may adjust the position and orientation of its first image (of a door) on its projected display. Whereby, using FIG. 26 for reference, first appliance 50 may modify the first image 220 such that an at least partially combined image is formed with the second image 221. Image rendering techniques (e.g., coordinate transformation matrices) may be adapted from current art.

Understandably, alternative types of projected and combined images may be presented by appliances 50 and 51 and coordinated by pointers 100 and 101, respectively. Alternative images may include, but not limited to, animated objects, characters, menus, cursors, and/or text. In some embodiments, a plurality of spatially aware pointers and respective appliances may combine a plurality of projected images into an at least partially combined image. In some embodiments, a plurality of spatially aware pointers and respective appliances may clip an at least one projected image so that a plurality of projected images do not overlap.

### Communicating Using Data Encoded Light

In some embodiments, a plurality of spatially aware pointers can communicate using data encoded light. Referring back to FIG. 21B, a perspective view shows first pointer 100 operatively coupled to first host appliance 50, and second pointer 101 operatively coupled to second host appliance 51. Pointer 101 may be constructed substantially similar to pointer 100 (FIG. 1), and appliance 51 may be constructed substantially similar to appliance 50 (FIG. 1).

In an example operation, users (not shown) may aim appliances 50 and 51 towards remote surface 224, such as, for example, a wall, floor, or tabletop. Whereupon, pointer 100 enables its indicator projector 124 to project data-encoded modulated light, transmitting a data message (e.g., Content=“Hello”).

Whereupon, second pointer 101 enables its viewing sensor 149 and detects the data-encoded modulated light on surface 224, such as from indicator 296. Pointer 101 demodulates and converts the data-encoded modulated light into a data message (e.g., Content=“Hello”). Understandably, second pointer 101 may send a data message back to first pointer 100 using data-encoded, modulated light.

Communicating with a Remote Device Using Data Encoded Light

In some embodiments, a spatially aware pointer can communicate with a remote device using data-encoded light. FIG. 28 presents a perspective view of pointer 100 operatively coupled to a host appliance 50. Further, a remote device 500, such as a TV set, having a display image 508 is located substantially near the pointer 100. The remote device 500 may further include a light receiver 506 such that device 500 may receive and convert data-encoded light into a data message.

Then in an example operation, a user (not shown) may wave hand 200 to the left along move path M4 (as denoted by arrow). The pointer's viewing sensor 148 may observe hand 200 and, subsequently, pointer 100 may analyze and detect a “left wave” hand gesture being made. Pointer 100 may further create and transmit a detect gesture data event (e.g., Event Type=GESTURE, Gesture Type=Left Wave) to appliance 50.

In response, appliance 50 may then transmit a send message data event (e.g., Event Type=SEND MESSAGE, Content=“Control code=33, Decrement TV channel”) to pointer 100. As indicated, the message event may include a control code. Standard control codes (e.g., code=33) and protocols (e.g., RC-5) for renote control devices may be adapted from current art.

Wherein, the pointer 100 may take receipt of the send message event and parse the message content, transforming the message content (e.g., code=33) into data-encoded modulated light projected by indicator projector 124.

The remote device 500 (and light receiver 506) may then receive and translate the data-encoded modulated light into a data message (e.g., code=33). The remote device 500 may respond to the message, such as decrementing TV channel to “CH-3”.

Understandably, pointer 100 may communicate other types of data messages or control codes to remote device 500 in response to other types of hand gestures. For example, waving hand 200 to the right may cause device 500 to increment its TV channel.

In some embodiments, the spatially aware pointer 100 may receive data-encoded modulated light a remote device, such as device 500; whereupon, pointer 100 may transform the data-encoded light into a message data event and transmit the event to the host appliance 50. Embodiments of remote devices include, but not limited to, a media player, a media recorder, a laptop computer, a tablet computer, a personal computer, a game system, a digital camera, a television set, a lighting system, or a communication terminal.

### Method to Send a Data Message

FIG. 29A presents a flow chart of a computer implemented method, which can wirelessly transmit a data message as data-encoded, modulated light to another device. The method may be implemented in the indicator encoder 115 and executed by the pointer control unit 108 (FIG. 1). The method may be continually invoked by a high-level method (e.g., step S102 of FIG. 4).

Beginning with step S400, if the pointer control unit 108 has been notified to send a message, the method continues to step S402. Otherwise, the method ends. Notification to send a message may come from the pointer and/or host appliance.

In step S402, pointer control unit 108 can create a SEND message data event (e.g., Event Type=SEND MESSAGE, Content=“Switch TV channel”) comprised of a data message. The contents of the data message may be based upon information (e.g., code to switch TV channel, text, etc.) from the pointer and/or host appliance. The control unit 108 may store the SEND message data event in event data 107 (FIG. 1) for future processing.

Finally, in step S408, pointer control unit 108 and indicator encoder 115 can enable the gesture projector 128 and/or the indicator projector 124 (FIG. 1) to project data-encoded light for transmitting the SEND message event of step S402. Data encoding, light modulation techniques (e.g., Manchester encoding) may be adapted from current art.

### Method to Receive a Data Message

FIG. 29B presents a flow chart of a computer implemented method, which receives data-encoded, modulated light from another device and converts it into a data message. The method may be implemented in the indicator decoder 116 and executed by the pointer control unit 108 (FIG. 1). The method may be continually invoked by high-level method (e.g., step S104 of FIG. 4).

Beginning with step S420, the pointer control unit 108 and indicator decoder 116 can access at least one light view in captured view data 104 (FIG. 1). Whereupon, pointer control unit 108 and indicator decoder 116 may analyze the light view(s) for variation in light intensity. The indicator decoder may decode the data-encoded, modulated light in the light view(s) into a RECEIVED message data event. The control unit 108 may store the RECEIVED message data event in event data 107 (FIG. 1) for future processing. Data decoding, light modulation techniques (e.g., Manchester decoding) may be adapted from current art.

In step S424, if the pointer control unit 108 can detect a RECEIVED message data event from step S420, the method continues to step S428, otherwise the method ends.

Finally, in step S428, pointer control unit 108 can access the RECEIVED message data event and transmit the event to the pointer data controller 110, which transmits the event via the data interface Ill to host appliance 50 (shown in FIG. 1). Wherein, the host appliance 50 may respond to the RECEIVED message data event.

### Example of a Message Data Event

FIG. 8A presents a data table of an example message data event D100, which includes message content. Message data event D00 may be stored in event data (FIG. 1, reference numeral 107). Message data event D100 may include data attributes such as, but not limited to, an event type D101, a pointer ID 102, an appliance ID 103, a message timestamp D104, and/or message content D105.

Event type D101 can identify the type of message event (e.g., event type=SEND MESSAGE or RECEIVED MESSAGE).

Pointer id D102 can uniquely identify a pointer (e.g., Pointer Id=“100”) associated with this event.

Appliance id D103 can uniquely identify a host appliance (e.g., Appliance Id=“50”) associated with this event.

Message timestamp D104 can designate time of day (e.g., timestamp=6:31:00 AM) that message was sent or received.

Message content D105 can include any type of multimedia content (e.g., graphics data, audio data, universal resource locator (URL) data, etc.) associated with this event.

### Second Embodiment of a Spatially Aware Pointer (Array-Based)

Turning to FIG. 30, thereshown is a block diagram that illustrates a second embodiment of a spatially aware pointer 600, which uses low-cost, array-based sensing. The pointer 600 can be operatively coupled to host appliance 50 that is mobile and handheld, augmenting appliance 50 with remote control, hand gesture detection, and 3D spatial depth sensing abilities. Moreover, the pointer 600 and appliance 50 can inter-operate as a spatially aware pointer system.

The pointer 600 can be constructed substantially similar to the first embodiment of pointer 100 (FIG. 1). The same reference numbers in different drawings identifies the same or similar elements. Whereby, for sake of brevity, the reader may refer to the first embodiment of pointer 100 (FIGS. 1-29) to understand the construction and methods of similar elements.

FIG. 30 depicts modifications to pointer 600 can include, but not limited to, the following: the gesture projector (FIG. 1, reference numeral 128) has been removed; an indicator projector 624 has replaced the previous indicator projector (FIG. 1, reference numeral 124); and a viewing sensor 648 has replaced the previous viewing sensor (FIG. 1, reference numeral 148).

Turning to FIGS. 31A and 31B, perspective views show the indicator projector 624 may be comprised of an array-based, light projector. FIG. 31B shows a close-up view of indicator projector 624 comprised of a plurality of light sources 625A and 625B, such as, but not limited to, light emitting diode-, fluorescent-, incandescent-, and/or laser diode-based light sources that generate visible and/or invisible light, although other types, numbers, and/or arrangements of light sources may be utilized in alternate embodiments. In the current embodiment, light sources 625A and 625B are light emitting diodes that generate at least infrared light. In some embodiments, indicator projector 624 can create a plurality of pointer indicators (e.g., FIG. 32, reference numerals 650 and 652) on one or more remote surfaces. In certain embodiments, indicator projector can create one or more pointer indicators having a predetermined shape or pattern of light.

FIGS. 31A and 31B also depict the viewing sensor 648 may be comprised of array-based, light sensors. FIG. 31B presents the viewing sensor 648 may be comprised of a plurality of light sensors 649, such as, but not limited to, photo diode-, photo detector-, optical receiver-, infrared receiver-, CMOS-, CCD-, and/or electronic camera-based light sensors that are sensitive to visible and/or invisible light, although other types, numbers, and/or arrangements of light sensors may be utilized in alternate embodiments.

In the current embodiment, viewing sensor 648 is sensitive to at least infrared light and may be comprised of a plurality of light sensors 649 that sense at least infrared light. In some embodiments, one or more light sensors 649 may view a predetermined view region on a remote surface. In certain embodiments, viewing sensor 648 may be comprised of a plurality of light sensors 649 that each form a field of view, wherein the plurality of light sensors 649 are positioned such that the field of view of each of the plurality of light sensors 649 diverge from each other (e.g., as shown by view regions 641-646 of FIG. 32).

Finally, appliance 50 may optionally include image projector 52, capable of projecting a visible image on one or more remote surfaces.

### Second Embodiment

### Protective Case as Housing

FIG. 31A shows the pointer 600 may be comprised of a housing 670 that forms at least a portion of a protective case or sleeve that can substantially encase a handheld electronic appliance, such as, for example, host appliance 50. As depicted in FIGS. 31A and 31B, indicator projector 624 and viewing sensor 648 are positioned in (or in association with) the housing 670 at a front end 172. Housing 670 may be constructed of plastic, rubber, or any suitable material. Thus, housing 670 may be comprised of one or more walls that can substantially encase, hold, and/or mount a host appliance. Walls W1-W5 may be made such that host appliance 50 mounts to the spatially aware pointer 600 by sliding in from the top (as indicated by arrow M). In some embodiments, housing 670 may have one more walls, such as wall W5, with a cut-out to allow access to features (e.g., touchscreen) of the appliance 50.

The pointer 600 may include a control module 604 comprised of, for example, one or more components of pointer 100, such as, for example, control unit 108, memory 102, data storage 103, data controller 110, data coupler 160, and/or supply circuit 112 (FIG. 30). In some embodiments, the pointer data coupler 160 may be accessible to a host appliance.

Whereby, when appliance 50 is slid into the housing 670, the pointer data coupler 160 can operatively couple to the host data coupler 161, enabling pointer 600 and appliance 50 to communicate and begin operation.

### Second Embodiment

### Example Operation of the Pointer

Pointer 600 may have methods and capabilities that are substantially similar to pointer 100 (of FIGS. 1-29), including remote control, gesture detection, and 3D spatial sensing abilities. So for sake of brevity, only a few details will be further discussed.

FIG. 32 presents two spatially aware pointers being moved about by two users (not shown) in an environment. The two pointers are operable to determine pointer indicator positions of each other on a remote surface. Wherein, first pointer 600 has been operatively coupled to first appliance 50, and a second pointer 601 has been operatively coupled to a second appliance 51. The second pointer 601 and second appliance 51 are assumed to be similar in construction and capabilities as first pointer 600 and first appliance 50, respectively.

In an example position sensing operation, first pointer 600 illuminates a first pointer indicator 650 on remote surface 224 by activating a first light source (e.g., FIG. 31B, reference numeral 625A). Concurrently, second pointer 601 observes the first indicator 650 by enabling a plurality of light sensors (e.g., FIG. 31B, reference numeral 649) that sense view regions 641-646. As can be seen, one or more view regions 643-645 contain various proportions of indicator 650. Whereupon, the second pointer 601 may determine a first indicator position (e.g., x=20, y=30, z=10) of first indicator 650 on remote surface 224 using, for example, computer vision techniques adapted from current art.

Next, first pointer 600 illuminates a second pointer indicator 652 by, for example, deactivating the first light source and activating a second light source (e.g., FIG. 31B, reference numeral 625B). The second pointer 601 observes the second indicator 652 by enabling a plurality of light sensors (e.g., FIG. 31B, reference numeral 649) that sense view regions 641-646. As can be seen, one or more view regions 643-645 contain various proportions of indicator 652. Whereupon, the second pointer 601 may determine a second indicator position (e.g., x=30, y=20, z=10) of second indicator 652 on remote surface 224 using, for example, computer vision techniques.

The second pointer 601 can then compute an indicator orientation vector IV from the first and second indicator positions (as determined above). Whereupon, the second pointer 601 can determine an indicator position and an indicator orientation of indicators 650 and 652 on one or more remote surfaces 224 in X-Y-Z Cartesian space.

In another example operation (not shown), the first pointer 600 may observe pointer indicators generated by the second pointer 601 and compute indicator positions. Wherein, pointers 600 and 601 can remain spatially aware of each other.

Understandably, some embodiments may enable a plurality of pointers (e.g., three and more) to be spatially aware of each other. Certain embodiments may use a different method utilizing a different number and/or combination of light sources and light sensors for spatial position sensing.

### Third Embodiment of a Spatially Aware Pointer (Improved 3D Sensing)

FIG. 33 presents a block diagram showing a third embodiment of a spatially aware pointer 700 with enhanced 3D spatial sensing abilities. Spatially aware pointer 700 can be operatively coupled to host appliance 50 that is mobile and handheld, augmenting appliance 50 with remote control, hand gesture detection, and 3D spatial depth sensing abilities. Moreover, the pointer 700 and host appliance 50 can inter-operate as a spatially aware pointer system.

Pointer 700 can be constructed substantially similar to the first embodiment of pointer 100 (FIG. 1). The same reference numbers in different drawings identifies the same or similar elements. Whereby, for sake of brevity, the reader may refer to the first embodiment of pointer 100 (FIGS. 1-29) to understand the construction and methods of similar elements.

However, modifications to pointer 700 can include, but not limited to, the following: the gesture projector (FIG. 1, reference numeral 128) has been removed; an indicator projector 724 has replaced the previous indicator projector (FIG. 1, reference numeral 124); and a wireless transceiver 113 has been added.

The wireless transceiver 113 is an optional (not required) component comprised of one or more wireless communication transceivers (e.g., RF-, Wireless USB-, Zigbee-, Bluetooth-, infrared-, ultrasonic-, and/or WiFi-based wireless transceiver). The transceiver 113 may be used to wirelessly communicate with other spatially aware pointers (e.g., similar to pointer 700), remote networks (e.g., wide area network, local area network, Internet, and/or other types of networks) and/or remote devices (e.g., wireless router, wireless WiFi router, wireless modem, and/or other types of remote devices).

As shown in FIG. 34, a perspective view depicts pointer 700 may be comprised of viewing sensor 148 and indicator projector 724, which may be located at the front end 172 of pointer 700. In the current embodiment, the viewing sensor 148 may be comprised of an image sensor that is sensitive to at least infrared light, such as, for example, a CMOS or CCD camera-based image sensor with an optical filter (e.g., blocking all light except infrared light). In alternate embodiments, other types of image sensors (e.g., visible light image sensor, etc.) may be used.

The indicator projector 724 may be comprised of at least one image projector (e.g., pico projector) capable of illuminating and projecting one or more pointer indicators (e.g., FIG. 35A, reference numeral 796) onto remote surfaces in an environment. The indicator projector 724 may generate light for remote control, hand gesture detection, and 3D spatial sensing abilities. Wherein, indicator projector 724 may generate a wide-angle light beam (e.g., of 20-180 degrees). In some embodiments, the indicator projector 724 may create at least one pointer indicator having a predetermined pattern or shape of light. In some embodiments, indicator projector may generate a plurality of pointer indicators in sequence or concurrently on one or more remote surfaces. The indicator projector 724 may be comprised of at least one Digital Light Processor (DLP)-, Liquid Crystal on Silicon (LCOS)-, light emitting diode (LED)-, fluorescent-, incandescent-, and/or laser-based image projector that generates at least infrared light, although other types of projectors, and/or types of illumination (e.g., visible light and/or invisible light) may be utilized in alternate embodiments.

Finally, appliance 50 may optionally include image projector 52, capable of projecting a visible image on one or more remote surfaces.

### Third Embodiment

### Protective Case as Housing

FIG. 34 shows pointer 700 may be comprised of a housing 770 that forms at least a portion of a protective case or sleeve that can substantially encase a mobile appliance, such as, for example, host appliance 50. Indicator projector 724 and viewing sensor 148 are positioned in (or in association with) the housing 770 at a front end 172. Housing 770 may be constructed of plastic, rubber, or any suitable material. Thus, housing 770 may be comprised of one or more walls that can substantially encase, hold, and/or mount a handheld appliance.

The pointer 700 includes a control module 704 comprised of, for example, one or more components of pointer 700, such as, for example, control unit 108, memory 102, data storage 103, data controller 110, data coupler 160, wireless transceiver 113, and/or supply circuit 112 (FIG. 33). In some embodiments, the pointer data coupler 160 may be accessible to a host appliance.

Whereby, when appliance 50 is slid into housing 770 (as indicated by arrow M), the pointer data coupler 160 can operatively couple to the host data coupler 161, enabling pointer 700 and appliance 50 to communicate and begin operation.

### Third Embodiment

### “Multi-Sensing” Pointer Indicator

FIG. 35A presents a perspective view of the pointer 700 and appliance 50 aimed at remote surfaces 224-226 by a user (not shown). As can be seen, the pointer's indicator projector 724 is illuminating a multi-sensing pointer indicator 796 on the remote surfaces 224-226, while the pointer's viewing sensor 148 can observe the pointer indicator 796 on surfaces 224-226. (For purposes of illustration, the pointer indicator 796 shown in FIGS. 35A-35B has been simplified, while FIG. 35C shows a detailed view of the pointer indicator 796.)

The multi-sensing pointer indicator 796 includes a pattern of light that enables pointer 700 to remotely acquire 3D spatial depth information of the physical environment and to optically indicate the pointer's 700 aimed target position and orientation on a remote surface to other spatially aware pointers. Wherein, indicator 796 may be comprised of a plurality of illuminated optical machine-discernible shapes or patterns, referred to as fiducial markers, such as, for example, distance markers MK and reference markers MR1, MR3, and MR5. The term “reference marker” generally refers to any optical machine-discernible shape or pattern of light that may be used to determine, but not limited to, a spatial distance, position, and orientation. The term “distance marker” generally refers to any optical machine-discernible shape or pattern of light that may be used to determine, but not limited to, a spatial distance. In the current embodiment, the distance markers MK are comprised of circular-shaped spots of light, and the reference markers MR1, MR3, and MR5 are comprised of ring-shaped spots of light. (For purposes of illustration, not all markers are denoted with reference numerals in FIGS. 35A-35C.)

The multi-sensing pointer indicator 796 may be comprised of at least one optical machine-discernible shape or pattern of light such that one or more spatial distances may be determined to at least one remote surface by the pointer 700. Moreover, the multi-sensing pointer indicator 796 may be comprised of at least one optical machine-discernible shape or pattern of light such that another pointer (not shown) can determine the relative spatial position, orientation, and/or shape of the pointer indicator 796. Note that these two such conditions are not necessarily mutually exclusive. The multi-sensing pointer indicator 796 may be comprised of at least one optical machine-discernible shape or pattern of light such that one or more spatial distances may be determined to at least one remote surface by the pointer 700, and another pointer can determine the relative spatial position, orientation, and/or shape of the pointer indicator 796.

FIG. 35C shows a detailed elevation view of the pointer indicator 796 on image plane 790 (which is an imaginary plane used to illustrate the pointer indicator). The pointer indicator 796 is comprised of a plurality of reference markers MR1-MR5, wherein each reference marker has a unique optical machine-discernible shape or pattern of light. Thus, the pointer indicator 796 may include at least one reference marker that is uniquely identifiable such that another pointer can determine a position, orientation, and/or shape of the pointer indicator 796.

A pointer indicator may include at least one optical machine-discernible shape or pattern of light that has a one-fold rotational symmetry and/or is asymmetrical such that an orientation can be determined on at least one remote surface. In the current embodiment, pointer indicator 796 includes at least one reference marker MR1 having a one-fold rotational symmetry and/or is asymmetrical. In fact, pointer indicator 796 includes a plurality of reference markers MR1-MR5 that have one-fold rotational symmetry and/or are asymmetrical. The term “one-fold rotational symmetry” denotes a shape or pattern that only appears the same when rotated 360 degrees. For example, the “U” shaped reference marker MR1 has a one-fold rotational symmetry since it must be rotated a full 360 degrees on the image plane 790 before it appears the same. Hence, at least a portion of the pointer indicator 796 may be optical machine-discernible and have a one-fold rotational symmetry such that the position, orientation, and/or shape of the pointer indicator 796 can be determined on at least one remote surface. The position marker 796 may include at least one reference marker MR1 having a one-fold rotational symmetry such that the position, orientation, and/or shape of the pointer indicator 796 can be determined on at least one remote surface. The position marker 796 may include at least one reference marker MR1 having a one-fold rotational symmetry such that another spatially aware pointer can determine a position, orientation, and/or shape of the pointer indicator 796.

### Third Embodiment

### 3D Spatial Depth Sensing

Returning to FIG. 35A, in an example 3D spatial depth sensing operation, pointer 700 and projector 724 first illuminate the surrounding environment with pointer indicator 796. Then while pointer indicator 796 appears on remote surfaces 224-226, the pointer 700 enables the viewing sensor 148 to capture one or more light views (e.g., image frames) of the spatial view forward of sensor 148.

So thereshown in FIG. 35B is an elevation view of an example captured light view 750 of the pointer indicator 796, wherein fiducial markers MR1 and MK are illuminated against an image background 752 that appears dimly lit. (For purposes of illustration, the observed pointer indicator 796 has been simplified.)

The pointer 700 may then use computer vision functions (e.g., FIG. 33, depth analyzer 119) to analyze the image frame 750 for 3D depth information. Namely, a positional shift will occur with the fiducial markers, such as markers MK and MR1, within the light view 750 that corresponds to distance.

Pointer 700 may compute one or more spatial surface distances to at least one remote surface, measured from pointer 700 to markers of the pointer indicator 796. As illustrated, the pointer 700 may compute a plurality of spatial surface distances SD1, SD2, SD3, SD4, and SD5, along with distances to substantially all other remaining fiducial markers within indicator 796 (FIG. 35C).

With known surface distances, the pointer 700 may further compute the location of one or more surface points that reside on at least one remote surface. For example, pointer 700 may compute the 3D positions of surface points SP2, SP4, and SP5, and other surface points to markers within indicator 796.

Then with known surface points, the pointer 700 may compute the position, orientation, andior shape of remote surfaces and remote objects in the environment. For example, the pointer 700 may aggregate surface points SP2, SP4, and SP4 (on remote surface 226) and generate a geometric 2D surface and 3D mesh, which is an imaginary surface with surface normal vector SN3. Moreover, other surface points may be used to create other geometric 2D surfaces and 3D meshes, such as geometrical surfaces with normal vectors SN1 and SN2. Finally, pointer 700 may use the determined geometric 2D surfaces and 3D meshes to create geometric 3D objects that represent remote objects, such as a user hand (not shown) in the vicinity of pointer 700. Whereupon, pointer 700 may store in data storage the surface points, 2D surfaces, 3D meshes, and 3D objects for future reference, such that pointer 700 is spatially aware of its environment.

### Third Embodiment

### High-Level Method of Operation

In FIG. 36, a flowchart of a high-level, computer implemented method of operation for the pointer 700 (FIG. 33) is presented, although alternative methods may also be considered. The method may be implemented, for example, in pointer program 114 (FIG. 33) and executed by the pointer control unit 108 (FIG. 33).

Beginning with step S700, the pointer 700 can initialize itself for operations, for example, by setting its data storage 103 (FIG. 33) with default data.

In step S704, the pointer 700 can briefly project and illuminate at least one pointer indicator on the remote surface(s) in the environment. Whereupon, the pointer 700 may capture one or more light views (or image frames) of the field of view forward of the pointer.

In step S706, the pointer 700 can analyze one or more the light views (from step S704) and compute a 3D depth map of the remote surface(s) and remote object(s) in the vicinity of the pointer.

In step S708, the pointer 700 may detect one or more remote surfaces by analyzing the 3D depth map (from step S706) and compute the position, orientation, and shape of the one or more remote surfaces.

In step S710, the pointer 700 may detect one or more remote objects by analyzing the detected remote surfaces (from step S708), identifying specific 3D objects (e.g., a user hand), and compute the position, orientation, and shape of the one or more remote objects.

In step S711, the pointer 700 may detect one or more hand gestures by analyzing the detected remote objects (from step S710), identifying hand gestures (e.g., thumbs up), and computing the position, orientation, and movement of the one or more hand gestures.

In step S712, the pointer 700 may detect one or more pointer indicators (from other pointers) by analyzing one or more light views (from step S704). Whereupon, the pointer can compute the position, orientation, and shape of one or more pointer indicators (from other pointers) on remote surface(s).

In step S714, the pointer 700 can analyze the previously collected information (from steps S704-S712), such as, for example, the position, orientation, and shape of the detected remote surfaces, remote objects, hand gestures, and pointer indicators.

In step S716, the pointer 700 can communicate data events (e.g., spatial information) with the host appliance 50 based upon, but not limited to, the position, orientation, and/or shape of the one or more remote surfaces (detected in step S708), remote objects (detected in step S710), hand gestures (detected in step S711), and/or pointer indicators from other devices (detected in step S712). Such data events can include, but not limited to, message, gesture, and/or pointer data events.

In step S717, the pointer 700 can update clocks and timers so that the pointer 700 can operate in a time-coordinated manner.

Finally, in step S718, if the pointer 700 determines, for example, that the next light view needs to be captured (e.g., every 1/30 of a second), then the method goes back to step S704. Otherwise, the method returns to step S717 to wait for the clocks to update.

### Third Embodiment

### Method for 3D Spatial Depth Sensing

Turning to FIG. 37A, presented is a flowchart of a computer implemented method that enables the pointer 700 (FIG. 33) to compute a 3D depth map using an illuminated pointer indicator, although alternative methods may be considered as well. The method may be implemented, for example, in the depth analyzer 119 (FIG. 33) and executed by the pointer control unit 108 (FIG. 33). The method may be continually invoked (e.g., every 1/30 second) by a high-level method (e.g., FIG. 36, step S706).

Starting with step S740, the pointer 700 can analyze at least one light view in the captured view data 107 (FIG. 33). This may be accomplished with computer vision techniques (e.g., edge detection, pattern recognition, image segmentation, etc.) adapted from current art. The pointer 700 attempts to locate one or more fiducial markers (e.g., markers MR1 and MK of FIG. 35B) of a pointer indicator (e.g., indicator 796 of FIG. 35B) within at least one light view (e.g., light view 750 of FIG. 35B). The pointer 700 may also compute the positions (e.g., sub-pixel centroids) of located fiducial markers of the pointer indicator within the light view(s). Computer vision techniques, for example, may include computation of“centroids” or position centers of the fiducial markers. One or more fiducial markers may be used to determine the position, orientation, and/or shape of the pointer indicator.

In step S741, the pointer 700 can try to identify at least a portion of the pointer indicator within the light view(s). That is, the pointer 700 may search for at least a portion of a matching pointer indicator pattern in a library of pointer indicator definitions (e.g., as dynamic and/or predetermined pointer indicator patterns), as indicated by step S742. The fiducial marker positions of the pointer indicator may aid the pattern matching process. Also, the pattern matching process may respond to changing orientations of the pattern within 3D space to assure robustness of pattern matching. To detect a pointer indicator, the pointer may use computer vision techniques (e.g., shape analysis, pattern matching, projective geometry, etc.) adapted from current art.

In step S743, if the pointer detects at least a portion of the pointer indicator, the method continues to step S746. Otherwise, the method ends.

In step S746, the pointer 700 can transform one or more fiducial marker positions (in at least one light view) into physical 3D locations outside of the pointer 700. For example, the pointer 700 may compute one or more spatial surface distances to one or more markers on one or more remote surfaces outside of the pointer (e.g., such as surface distances SD1-SD5 of FIG. 35A). Spatial surface distances may be computed using computer vision techniques (e.g., triangulation, etc.) for 3D depth sensing. Moreover, the pointer 700 may compute a 3D depth map of one or more remote surfaces. The 3D depth map may be comprised of 3D positions of one or more surface points (e.g., FIG. 35A, surface points SP2, SP4, and SP5) residing on at least one remote surface.

In step S748, the pointer 700 can assign metadata to the 3D depth map (from step S746) for easy lookup (e.g., 3D depth map id=1, surface point id=1, surface point position=[10,20,50], etc.). The pointer 700 may then store the computed 3D depth map in spatial cloud data 105 (FIG. 33) for future reference. Whereupon, the method ends.

### Third Embodiment

### Method for Detecting Remote Surfaces and Remote Objects

Turning now to FIG. 37B, a flowchart is presented of a computer implemented method that enables the pointer to compute the position, orientation, and shape of remote surfaces and remote objects in the environment of the pointer 700 (FIG. 33), although alternative methods may be considered. The method may be implemented, for example, in the surface analyzer 120 (FIG. 33) and executed by the pointer control unit 108 (FIG. 33). The method may be continually invoked (e.g., every 1/30 second) by a high-level method (e.g., FIG. 36, step S708).

Beginning with step S760, the pointer 700 can analyze the geometrical surface points (e.g., from step S748 of FIG. 37A) that reside on at least one remote surface. For example, the pointer constructs geometrical 2D surfaces by associating groups of surface points that are, but not limited to, coplanar and/or substantially near each other. The 2D surfaces may be constructed as geometric polygons in 3D space. Positional inaccuracy (or jitter) of surface points may be noise reduced, for example, by computationally averaging similar points continually collected in real-time and/or removing outlier points.

In step S762, the pointer 700 may assign metadata to each computed 2D surface (from step S760) for easy lookup (e.g., surface id=30, surface type-planar, surface position=[10,20,5; 15,20,5; 15,30,5]; etc.). The pointer 700 can store the generated 2D surfaces in spatial cloud data 105 (FIG. 33) for future reference.

In step S763, the pointer 700 can create one or more geometrical 3D meshes from the collected 2D surfaces (from step S762). A 3D mesh is a polygon approximation of a surface, often constituted of triangles, that represents a planar or non-planar remote surface. To construct a mesh, polygons or 2D surfaces may be aligned and combined to form a seamless, geometrical 3D mesh. Open gaps in the 3D mesh may be filled. Mesh optimization techniques (e.g., smoothing, polygon reduction, etc.) may be adapted from current art. Positional inaccuracy (or jitter) of the 3D mesh may be noise reduced, for example, by computationally averaging a plurality of 3D meshes continually collected in real-time.

In step S764, the pointer 700 may assign metadata to one or more 3D meshes for easy lookup (e.g., mesh id=1, timestamp=“12:00:01 AM”, mesh vertices=[10,20,5; 10,20,5; 30,30,5; 10,30,5]; etc.). The pointer 700 may then store the generated 3D meshes in spatial cloud data 105 (FIG. 33) for future reference.

Next, in step S766, the pointer 700 can analyze at least one 3D mesh (from step S764) for identifiable shapes of physical objects, such as a user hand, etc. Computer vision techniques (e.g., 3D shape matching) may be adapted from current art to match a library of object shapes (e.g., object models of a user hand, etc.), shown in step S767. For each matched shape, the pointer 700 may generate a geometrical 3D object (e.g., object model of user hand) that defines the physical object's location, orientation, and shape. Noise reduction techniques (e.g., 3D object model smoothing, etc.) may be adapted from current art.

In step S768, the pointer 700 may assign metadata to each created 3D object (from step S766) for easy lookup (e.g., object id=1, object type=hand, object position=[100,200,50 cm], object orientation=[30,20,10 degrees], etc.). The pointer may store the generated 3D objects in spatial cloud data 105 (FIG. 33) for future reference. Whereupon, the method ends.

### Third Embodiment

### Reduced Distortion of Projected Image on Remote Surfaces

FIG. 38 shows a perspective view of the pointer 700 and host appliance 50 aimed at remote surfaces 224-226, wherein the appliance 50 has generated projected image 220. In an example operation, the pointer 700 can determine the position, orientation, and shape of at least one remote surface in its environment, such as surfaces 224-226 with defined surface normal vectors SN1-SN3. Whereupon, the pointer 700 can create and transmit a pointer data event (including a 3D spatial model of remote surfaces 224-226) to appliance 700. Upon receiving the pointer data event, the appliance 700 may create at least a portion of the projected image 220 that is substantially uniformly lit and/or substantially devoid of image distortion on at least one remote surface.

### Third Embodiment

### Method for Reducing Distortion of Projected Image

FIG. 39 presents a sequence diagram of a computer implemented method that enables a pointer and host appliance to modify a projected image such that, but not limited to, at least a portion of the projected image is substantially uniformly lit, and/or substantially devoid of image distortion on at least one remote surface, although alternative methods may be considered as well. The operations for pointer 700 (FIG. 33) may be implemented in pointer program 114 and executed by the pointer control unit 108. Operations for appliance 50 (FIG. 33) may be implemented in host program 56 and executed by host control unit 54.

So starting with step S780, the pointer 100 can activate a pointer indicator and capture one or more light views of the pointer indicator.

In step S782, the pointer 100 can detect and determine the spatial position, orientation, and/or shape of one or more remote surfaces and remote objects.

Then in step S784, the pointer 100 can create a pointer data event (e.g., FIG. 8C) comprised of a 3D spatial model including, for example, the spatial position, orientation, and/or shape of the remote surface(s) and remote object(s). The pointer 100 can transmit the pointer data event (including the 3D spatial model) to the host appliance 50 via the data interface 111 (FIG. 33).

Then in step S786, the host appliance 50 can take receipt of the pointer data event that includes the 3D spatial model of remote surface(s) and remote object(s). Whereupon, the appliance 50 can pre-compute the position, orientation, and shape of a full-sized projection region (e.g., projection region 210 in FIG. 38) based upon the received pointer data event from pointer 100.

In step S788, the host appliance 50 can pre-render a projected image (e.g. in off-screen memory) based upon the received pointer data event from pointer 100, and may include the following enhancements:

Appliance 50 may adjust the brightness of the projected image based upon the received pointer data event from pointer 100. For example, image pixel brightness of the projected image may be boosted in proportion to the remote surface distance (e.g., region R2 has a greater surface distance than region R1 in FIG. 38), to counter light intensity fall-off with distance. In some embodiments, appliance 50 may modify a projected image such that the brightness of the projected image adapts to the position, orientation, and/or shape of at least one remote surface. In some embodiments, appliance 50 may modify at least a portion of the projected image such that the at least a portion of the projected image appears substantially uniformly lit on at least one remote surface, irrespective of the position, orientation, and/or shape of the at least one remote surface.

The appliance 50 may modify the shape of the projected image (e.g., projected image 220 has clipped edges CLP in FIG. 38) based upon the received pointer data event from pointer 100. Image shape modifying techniques may be adapted from current art. Appliance 50 may modify a shape of a projected image such that the shape of the projected image adapts to the position, orientation, and/or shape of at least one remote surface. Appliance 50 may modify a shape of a projected image such that the projected image does not substantially overlap another projected image (from another handheld projecting device) on at least one remote surface.

The appliance 50 may inverse warp or pre-warp the projected image (e.g., to reduce keystone distortion) based upon the received pointer data event from pointer 100. This may be accomplished with image processing techniques (e.g., inverse coordinate transforms, homography, projective geometry, scaling, rotation, translation, etc.) adapted from current art. Appliance 50 may modify a projected image such that the projected image adapts to the one or more surface distances to the at least one remote surface. Appliance 50 may modify a projected image such that at least a portion of the projected image appears to adapt to the position, orientation, and/or shape of the at least one remote surface. Appliance 50 may modify the projected image such that at least a portion of the projected image appears substantially devoid of distortion on at least one remote surface.

Finally, in step S790, the appliance 50 enables the illumination of the projected image (e.g., image 220 in FIG. 38) on at least one remote surface.

### Third Embodiment

### Hand Gesture Sensing with Pointer Indicator

Turning now to FIG. 40A, thereshown is a perspective view (of infrared light) of pointer 700, while a user hand 206 is making a hand gesture in a leftward direction, as denoted by move arrow M2.

In an example operation, pointer 700 and indicator projector 724 can illuminate the surrounding environment with a pointer indicator 796 comprised of fiducial markers (e.g., markers MK and MR4). Then as the pointer indicator 796 appears on the user hand 206, pointer 700 can enable viewing sensor 148 to capture one or more light views forward of sensor 148.

Whereupon, pointer 700 can use computer vision to compute one or more spatial surface distances (e.g., surface distances SD7 and SD8) to at least one remote surface and/or remote object, such as the user hand 206. Pointer 700 may further compute surface points, 2D surfaces, 3D meshes, and finally, a 3D object that represents hand 206.

Pointer 700 may then make hand gesture analysis of the 3D object that represents the user hand 206. If a hand gesture is detected, the pointer 700 can create and transmit a gesture data event (e.g., FIG. 8B) to the host appliance 50. Whereupon, the host appliance 50 can generate multimedia effects based upon the received gesture data event from the pointer 700.

FIG. 40B shows a perspective view (of visible light) of the pointer 700, while the user hand 206 is making a hand gesture in a leftward direction. Upon detecting a hand gesture from user hand 206, the appliance 50 may modify the projected image 220 created by image projector 52. In this case, the projected image 220 presents a graphic cursor (GCUR) that moves (as denoted by arrow M2′) in accordance to the movement (as denoted by arrow M2) of the hand gesture of user hand 206. Understandably, alternative types of hand gestures and generated multimedia effects in response to the hand gestures may be considered as well.

### Third Embodiment

### Method for Hand Gesture Sensing

The hand gesture sensing method depicted earlier in FIG. 7 (from the first embodiment) may be adapted for use in the third embodiment.

### Third Embodiment

### Touch Hand Gesture Sensing

Turning now to FIG. 41A, thereshown is a perspective view (of infrared light) of pointer 700, while a user hand 206 is making a touch hand gesture (as denoted by arrow M3), wherein the hand 206 touches the surface 227 at touch point TP.

In an example operation, pointer 700 and indicator projector 724 can illuminate the surrounding environment with a pointer indicator 796 comprised of fiducial markers (e.g., markers MK and MR4). Then as the pointer indicator 796 appears on the user hand 206, pointer 700 can enable viewing sensor 148 to capture one or more light views forward of sensor 148.

Whereupon, pointer 700 can use computer vision to compute one or more spatial surface distances (e.g., surface distances SD1-SD6) to at least one remote surface and/or remote object, such as, for example, the user hand 206 and remote surface 227. Pointer 700 may further compute surface points, 2D surfaces, 3D meshes, and finally, a 3D object that represents hand 206.

Pointer 700 may then make touch hand gesture analysis of the 3D object that represents the user hand 206 and the remote surface 227. If a touch hand gesture is detected (e.g., such as when hand 206 moves and touches the remote surface 227 at touch point TP), the pointer 700 can create and transmit a touch gesture data event (e.g., FIG. 8B) to the host appliance 50. Whereupon, the host appliance 50 can generate multimedia effects based upon the received touch gesture data event from the pointer 700.

FIG. 41B shows a perspective view (of visible light) of the pointer 700, while the user hand 206 has touched the remote surface 227, making a touch hand gesture. Upon detecting a touch hand gesture from the user hand 206, the appliance 50 may modify the projected image 220 created by image projector 52. In this case, after the user touches icon GICN reading “Tours”, appliance 50 can modify the projected image 220 and icon GICN to read “Prices”. Understandably, alternative types of touch hand gestures and generated multimedia effects in response to touch hand gestures may be considered as well.

### Third Embodiment

### Method for Touch Hand Gesture Sensing

The touch hand gesture sensing method depicted earlier in FIG. 10 (from the first embodiment) may be adapted for use in the third embodiment.

### Third Embodiment

### General Method of Spatial Sensing for a Plurality of Pointers

A plurality of spatially aware pointers may provide spatial sensing capabilities for a plurality of host appliances. So turning ahead to FIGS. 42A-42D, a collection of perspective views show first pointer 700 has been operatively coupled to first host appliance 50, while second pointer 701 has been operatively coupled to second host appliance 51. Second pointer 701 may be constructed similar to first pointer 700 (FIG. 33), while second appliance 51 may be constructed similar to first appliance 50 (FIG. 33).

To enable spatial sensing using a plurality of pointers (as shown in FIGS. 42A-42D), the sequence diagram depicted earlier in FIG. 20 may be adapted for use. However, steps S314 and S330 may be further modified such that pointers 700 and 701 have enhanced 3D depth sensing, as discussed below.

### Third Embodiment

### Example of Spatial Sensing for a Plurality of Pointers

First Phase:

In an example first phase of operation, while turning to FIG. 42A, the first pointer 700 and its indicator projector 724 illuminate a multi-sensing pointer indicator 796 on remote surface 224. First pointer 700 can then enable its viewing sensor 148 to capture one or more light views of view region 230, which includes the illuminated pointer indicator 796. Then using computer vision techniques, pointer 700 can complete 3D depth sensing of one or more remote surfaces in its environment. For example, pointer 700 can compute surface distances SD1-SD3 to surface points SP1-SP3, respectively. Whereby, pointer 700 can further determine the position and orientation of one or more remote surfaces, such as remote surface 224 (e.g., defined by surface normal SN1) in Cartesian space X-Y-Z.

Then in FIG. 42B, first pointer 700 and its indicator projector 724 illuminates the multi-sensing pointer indicator 796. But this time, the second pointer 701 and its viewing sensor 149 can capture one or more light views of view region 231, which includes the illuminated pointer indicator 796. Using computer vision techniques, second pointer 701 can determine the position and orientation of the pointer indicator 796 in Cartesian space X′-Y′-Z′. That is, second pointer 701 can compute indicator height IH, indicator width IW, indicator vector IV, indicator orientation IR, and indicator position IP (e.g., similar to the second pointer 101 in FIG. 21B). Moreover, second pointer 701 may further determine the position and orientation of the first pointer 700 in Cartesian space X′-Y′-Z′(e.g., similar to the second pointer 101 in FIG. 21B).

FIG. 42C shows that second pointer 701 may further determine its own position and orientation in Cartesian space X′-Y′-Z′(e.g., similar to second pointer 101 in FIG. 21C).

Second Phase:

Although not illustrated for sake of brevity, the second phase of the sensing operation may be further completed. That is, using FIG. 42A as a reference, the second pointer 701 can illuminate a second pointer indicator (not shown) and complete 3D depth sensing of one or more remote surfaces, similar to the 3D depth sensing operation of the first pointer 700 in the first phase. Then using FIG. 42B as a reference, the first pointer 700 can compute the position and orientation of the second pointer indicator, similar to pointer indicator sensing operation of the second pointer 701 in the first phase.

Finally, the sequence diagram of FIG. 20 (from the first embodiment) can be adapted for use with the third embodiment, such that the first and second pointers are capable of 3D depth sensing of one or more remote surfaces. For example, steps S306-S334 may be continually repeated so that pointers and appliances remain spatially aware of each other.

### Third Embodiment

### Method for Illuminating and Viewing a Pointer Indicator

The illuminating indicator method depicted earlier in FIG. 23 (from the first embodiment) may be adapted for use in the third embodiment.

### Third Embodiment

### Method for Pointer Indicator Analysis

The indicator analysis method depicted earlier in FIG. 24 (from the first embodiment) may be adapted for use in the third embodiment.

### Third Embodiment

### Example of a Pointer Data Event

The data example of the pointer event depicted earlier in FIG. 8C (from the first embodiment) may be adapted for use in the third embodiment. Understandably, the 3D spatial model D310 and other data attributes may be enhanced with additional spatial information.

### Third Embodiment

### Calibrating a Plurality of Pointers and Appliances (with Projected Images)

The calibration method depicted earlier in FIG. 25 (from the first embodiment) may be adapted for use in the third embodiment.

### Third Embodiment

### Computing Position of Projected Images

Computing the position and orientation of projected images depicted earlier in FIG. 25 (from the first embodiment) may be adapted for use in the third embodiment.

### Third Embodiment

### Interactivity of Projected Images

The operation of interactive projected images depicted earlier in FIG. 26 (from the first embodiment) may be adapted for use in the third embodiment. However, turning specifically to FIG. 42D, thereshown is a perspective view of first and second pointers 700 and 701 that are spatially aware of each other and provide 3D depth sensing information to host appliances 50 and 51, respectively. As shown, first appliance illuminates a first projected image 220 (of a dog), while second appliance 51 illuminates a second projected image 221 (of a cat).

Since the pointers 700 and 701 have enhanced 3D depth sensing abilities, the projected images 220 and 221 may be modified (e.g., by control unit 108 of FIG. 33) to substantially reduce distortion and correct illumination on remote surface 224, irrespective of the position and orientation of pointers 700 and 701 in Cartesian space. For example, non-illuminated projection regions 210-211 show keystone distortion, yet the illuminated projected images 220-221 show no keystone distortion.

### Third Embodiment

### Combining Projected Images

The operation of the combined projected image depicted earlier in FIG. 27 (from the first embodiment) may be adapted for use in the third embodiment.

### Fourth Embodiment of a Spatially Aware Pointer (for 3D Mapping)

FIG. 43 presents a block diagram showing a fourth embodiment of a spatially aware pointer 800, which can be operatively coupled to a host appliance 46 that is mobile and handheld, augmenting appliance 46 with 3D mapping abilities. Moreover, the pointer 800 and host appliance 46 can inter-operate as a spatially aware pointer system.

Pointer 800 can be constructed substantially similar to the third embodiment of the pointer 700 (FIG. 33). The same reference numbers in different drawings identifies the same or similar elements. Whereby, for sake of brevity, the reader may refer to the third embodiment of pointer 700 (FIGS. 33-42) to understand the construction and methods of similar elements. However, modifications to pointer 800 may include, but not limited to, the following: the indicator analyzer (FIG. 33, reference numeral 121), gesture analyzer (FIG. 33, reference numeral 122), and wireless transceiver (FIG. 33, reference numeral 113) have been removed; and a spatial sensor 808 has been added.

The spatial sensor 802 is an optional component (as denoted by dashed lines) that can be operatively coupled to the pointer's control unit 108 to enhance spatial sensing. Whereby, the control unit 108 can take receipt of, for example, the pointer's 800 spatial position and/or orientation information (in 3D Cartesian space) from the spatial sensor 802. The spatial sensor may be comprised of an accelerometer, a gyroscope, a global positioning system device, and/or a magnetometer, although other types of spatial sensors may be considered.

Finally, the host appliance 46 is constructed similar to the previously described appliance (e.g., reference numeral 50 of FIG. 33); however, appliance 46 does not include an image projector.

### Fourth Embodiment

### Protective Case as Housing

As shown in FIG. 44, a perspective view shows pointer 800 of a housing 870 that forms at least a portion of a protective case or sleeve that can substantially encase a mobile appliance, such as, for example, host appliance 46. Indicator projector 724 and viewing sensor 148 are positioned in (or in association with) the housing 870 at a side end 173 of pointer 800, wherein the side end 173 is spatially longer than a front end 172 of pointer 800. Such a configuration allows projector 724 and sensor 148 to be positioned farther apart (than previous embodiments) enabling pointer 800 to have increased 3D spatial sensing resolution.

Housing 870 may be constructed of plastic, rubber, or any suitable material. Thus, housing 870 may be comprised of one or more walls that can substantially encase, hold, and/or mount a handheld appliance.

The pointer 800 includes a control module 804 comprised of one or more components, such as the control unit 108, memory 102, data storage 103, data controller 110, data coupler 160, motion sensor 802, and/or supply circuit 112 (FIG. 43). In some embodiments, the pointer data coupler 160 may be accessible to a host appliance.

Whereby, when appliance 46 is slid into housing 870 (as indicated by arrow M), the pointer data coupler 160 can operatively couple to the host data coupler 161, enabling pointer 800 and appliance 46 to communicate and begin operation.

### Fourth Embodiment

### 3D Spatial Mapping of the Environment

So turning to FIG. 45, there presented is a user 202 holding the pointer 800 and appliance 46 with the intent to create a 3D spatial model of at least a portion of an environment 820. So in an example operation, the user 202 aims and moves the pointer 800 and appliance 46 throughout 3D space, aiming the viewing sensor 148 (FIG. 44) at surrounding surfaces and objects of the environment 820, including surfaces 224-227, fireplace 808, chair 809, and doorway 810. For example, the pointer 800 may be moved along path M1 to path M2 to path M3, such that the pointer 800 can acquire a plurality of 3D depth maps from various pose positions and orientations of the pointer 800 in the environment 820. Moreover, the pointer 800 may be aimed upwards and/or downwards (e.g., to view surfaces 226 and 227) and moved around remote objects (e.g., chair 809) to acquire additional 3D depth maps. Once complete, the user 202 may indicate to the pointer 800 (e.g., by touching the host user interface of appliance 46, which notifies the pointer 800) that 3D spatial mapping is complete.

Whereupon, pointer 800 can then computationally transform the plurality of acquired 3D depth maps into a 3D spatial model that represents at least a portion of the environment 820, one or more remote objects, and/or at least one remote surface. In some embodiments, the pointer 800 can acquire at least a 360-degree view of an environment and/or one or more remote objects (e.g., by moving pointer 800 through at least a 360 degree angle of rotation on one or more axis, as depicted by paths M1-M3), such that the pointer 800 can compute a 3D spatial model that represents at least a 360 degree view of the environment and/or one or more remote objects. In certain embodiments, a 3D spatial model may be comprised of at least one computer-aided design (CAD) data file, 3D object model data file, and/or 3D computer graphic data file. In some embodiments, pointer 800 can compute one or more 3D spatial models that represent at least a portion of an environment, one or more remote objects, and/or at least one remote surface.

The pointer 800 can then create and transmit a pointer data event (comprised of the 3D spatial model) to the host appliance 46. Whereupon, the host appliance 46 can operate based upon the received pointer data event comprised of the 3D spatial model. For example, host appliance 46 can complete operations, such as, but not limited to, render a 3D image based upon the 3D spatial model, transmit the 3D spatial model to a remote device, or upload the 3D spatial model to an internet website.

### Fourth Embodiment

### Method for 3D Spatial Mapping of the Environment

Turning now to FIG. 46, a flowchart is presented of a computer implemented method that enables the pointer 800 (FIG. 43) to compute a 3D spatial model, although alternative methods may be considered. The method may be implemented, for example, in the surface analyzer 120 (FIG. 43) and executed by the pointer control unit 108 (FIG. 43).

Beginning with step S800, the pointer can initialize, for example, data storage 103 (FIG. 43) in preparation for 3D spatial mapping of an environment.

In step S802, a user can move the handheld pointer 800 and host appliance 46 (FIG. 43) through 3D space, aiming the pointer towards at least one remote surface in the environment.

In step S804, the pointer (e.g., using its 3D depth analyzer) can compute a 3D depth map of the at least one remote surface in the environment. Wherein, the pointer may use computer vision to generate a 3D depth map (e.g., as discussed in FIG. 37A). The pointer may further (as an option) take receipt of the pointer's spatial position and/or orientation infomnnation from the spatial sensor 808 (FIG. 43) to augment the 3D depth map information. The pointer then stores the 3D depth map in data storage 103 (FIG. 43).

In step S806, if the pointer determines that the 3D spatial mapping is complete, the method continues to step S810. Otherwise the method returns to step S802. Determining completion of the 3D spatial mapping may be based upon, but not limited to, the following: 1) the user indicates to the host appliance via the user interface 60 (FIG. 43); or 2) the pointer has sensed at least a portion of the environment, one or more remote objects, and/or at least one remote surface.

In step S810, the pointer (e.g., using its surface analyzer) can computationally transform the successively collected 3D depth maps (from step S804) into 2D surfaces, 3D meshes, and 3D objects (e.g., as discussed in FIG. 37B).

Then in step S812, the pointer (e.g., using its surface analyzer) can computationally transform the 2D surfaces, 3D meshes, and 3D objects (from step S810) into a 3D spatial model that represents at least a portion of the environment, one or more remote objects, and/or at least one remote surface. In some embodiments, the 3D spatial model may be comprised of at least one computer-aided design (CAD) data file, 3D object model data file, and/or 3D computer graphic data file. In some embodiments, computer vision functions (e.g., iterated closest point function, coordinate transformation matrices, etc.) adapted from current art may be used to align and transform the collected 2D surfaces, 3D meshes, and 3D objects into a 3D spatial model.

In step S814, the pointer can create a pointer data event (comprised of the 3D spatial model from step S812) and transmit the pointer data event to the host appliance 46 via the data interface 111 (FIG. 43).

Finally, in step S816, the host appliance 46 (FIG. 43) can take receipt of the pointer data event (comprised of the 3D spatial model) and operate based upon the received pointer data event. In detail, the host appliance 46 and host control unit 54 (FIG. 43) can utilize the 3D spatial model by one or more applications in the host program 56 (FIG. 43). For example, host appliance 46 can complete operations, such as, but not limited to, render a 3D image based upon the 3D spatial model, transmit the 3D spatial model to a remote device, or upload the 3D spatial model to an internet website.

### Fifth Embodiment of a Spatially Aware Pointer (for 3D Mapping)

FIG. 47 presents a block diagram showing a fifth embodiment of a spatially aware pointer 900, which can be operatively coupled to host appliance 46 that is mobile and handheld, augmenting appliance 46 with 3D mapping abilities. Moreover, pointer 900 and host appliance 46 can inter-operate as a spatially aware pointer system.

Pointer 900 can be constructed substantially similar to the fourth embodiment of the pointer 800 (FIG. 43). The same reference numbers in different drawings identifies the same or similar elements. Whereby, for sake of brevity, the reader may refer to the fourth embodiment of pointer 800 (FIGS. 43-46) to understand the construction and methods of similar elements. However, modifications to pointer 900 can include, but not limited to, the following: the indicator projector (FIG. 43, reference numeral 724) has been replaced with a second viewing sensor 149. The second viewing sensor 149 can be constructed similar to viewing sensor 148.

### Fifth Embodiment

### Protective Case as Housing

As shown in FIG. 48, a perspective view shows pointer 900 can be comprised of viewing sensors 148 and 149, which may be positioned within (or association with) housing at a side end 173 of pointer 900, wherein the side end 173 is spatially longer than a front end 172 of pointer 900. Such a configuration allows sensor 148 and 149 to be positioned farther apart (than previous embodiments) enabling pointer 900 to have increased 3D spatial sensing resolution. Whereby, when appliance 46 is slid into the protective case of pointer 900 (as indicated by arrow M), the pointer 900 and appliance 46 can communicate and begin operation.

### Fifth Embodiment

### 3D Spatial Mapping of an Environment

Creating a 3D spatial model that can represent at least a portion of an environment as depicted earlier in FIG. 45 (from the fourth embodiment) may be adapted for use in the fifth embodiment.

### Fifth Embodiment

### Method for 3D Spatial Mapping of an Environment

A method for creating a 3D spatial model that can represent at least a portion of an environment as depicted earlier in FIG. 46 (from the fourth embodiment) may be adapted for use in the fifth embodiment. However, instead of using structured light (e.g., from an indicator projector) for 3D spatial depth sensing, the pointer 900 shown in FIG. 48 utilizes viewing sensors 148 and 149 for stereovision 3D spatial depth sensing. Spatial depth sensing based on stereovision computer techniques (e.g., feature matching, spatial depth computation, etc.) may be adapted from current art.

### Other Embodiments of a Spatially Aware Pointer

In some alternate embodiments, a spatially aware pointer may be comprised of a housing having any shape or style. For example, pointer 100 (of FIG. 1) may utilize the protective case housing 770 (of FIG. 34), or pointers 700, 800, and 900 (of FIGS. 33, 43, and 47, respectively) may utilize the compact housing 170 (of FIG. 2).

In some alternate embodiments, a spatially aware pointer may not require the indicator encoder 115 and/or indicator decoder 116 (e.g., as in FIG. 1 or 30) if there is no need for data-encoded modulated light.

Various alternatives and embodiments are contemplated as being within the scope of the following claims particularly pointing out and distinctly claiming the subject matter regarded as the invention.

I claim:

1. A spatially aware pointer for use with a host appliance that is mobile and handheld, comprising:
a control unit disposed within a housing;
a data coupler disposed in association with the housing to enable communication between the pointer and the host appliance;
an indicator projector positioned in the housing and operatively coupled to the control unit, wherein the indicator projector illuminates a pointer indicator on an at least one remote surface; and
a viewing sensor positioned in the housing and operatively coupled to the control unit, wherein the viewing sensor captures one or more light views of the at least one remote surface.

2. The pointer of claim 1, wherein the indicator projector projects at least infrared light and the viewing sensor is sensitive to at least infrared light.

3. The pointer of claim 1, wherein the pointer indicator is comprised of data-encoded modulated light.

4. The pointer of claim 1, wherein the pointer indicator is comprised of a shape or pattern having a one-fold rotational symmetry.

5. The pointer of claim 1, wherein the viewing sensor captures one or more light views of an at least a portion of the pointer indicator, and wherein the pointer further comprises a depth analyzer that analyzes the one or more light views of the at least a portion of the pointer indicator and computes one or more surface distances to the at least one remote surface.

6. The pointer of claim 1, wherein the viewing sensor captures one or more light views of an at least a portion of the pointer indicator, and wherein the pointer further comprises a depth analyzer that analyzes the one or more light views of the at least a portion of the pointer indicator and computes one or more 3D depth maps of the at least one remote surface.

7. The pointer of claim 6, wherein the pointer further comprises a surface analyzer that analyzes the one or more 3D depth maps and constructs a 3D spatial model that represents the at least one remote surface.

8. The pointer of claim 7, wherein the pointer creates and transmits a data event comprising the 3D spatial model to the host appliance.

9. The pointer of claim 7, wherein the 3D spatial model is comprised of an at least one computer-aided design (CAD) data file, 3D model data file, and/or 3D computer graphic data file.

10. The pointer of claim 1 further comprising a gesture analyzer that detects and identifies a type of hand gesture from a user, wherein the pointer creates and transmits a data event comprising the type of hand gesture to the host appliance.

11. The pointer of claim 10, wherein the type of hand gesture includes a touch gesture that corresponds to a user touching the at least one remote surface.

12. The pointer of claim 1 further comprising an indicator analyzer operable to analyze the one or more light views to detect at least a portion of a second pointer indicator from a second spatially aware pointer and compute an indicator position of the second pointer indicator.

13. The pointer of claim 12, wherein the pointer is operable to create and transmit a data event comprising the indicator position of the second pointer indicator to the host appliance.

14. The pointer of claim 1, wherein the housing is configured to receive the preexisting host appliance.

15. A spatially aware pointer for use with a host appliance, comprising:
a housing separate from the host appliance;
a control unit disposed within the housing;
a data coupler positioned to communicate between the control unit of the pointer and the host appliance;
an indicator projector positioned in the housing and operatively coupled to the control unit to illuminate a pointer indicator on at least one remote surface; and
a viewing sensor positioned in the housing and operatively coupled to the control unit to capture one or more light views of the at least one remote surface,
wherein the control unit communicates a data event to the host appliance through the data coupler such that the host appliance operates based upon the data event from the pointer.

16. The pointer of claim 15, wherein the control unit generates the data event to the host appliance based upon the one or more light views from the viewing sensor.

17. The pointer of claim 15, wherein the host appliance includes at least a host image projector, wherein the host appliance operates the host image projector based upon the data event.

18. The pointer of claim 15, wherein the housing is configured to receive the preexisting host appliance.

19. The pointer of claim 15, wherein the indicator projector projects at least infrared light and the viewing sensor is sensitive to at least infrared light.

20. A method for utilizing a spatially aware pointer in association with a host appliance that is mobile and handheld, the method comprising:
establishing a communication link between the host appliance and the pointer through a data coupler, the pointer comprising:
a housing;
the data coupler disposed in association with the housing;
a control unit disposed within the housing;
an indicator projector operatively coupled to the control unit and operable to illuminate a pointer indicator on an at least one remote surface; and
a viewing sensor operatively coupled to the control unit and operable to capture one or more light views of the at least one remote surface;
generating a data event signal in the control unit based upon the one or more light views; and
controlling the operation of the host appliance based upon the data event signal from the pointer.

21. The method of claim 20, wherein the viewing sensor captures one or more light views of an at least a portion of the pointer indicator, and wherein the pointer further comprises a depth analyzer to analyze the one or more light views of the at least a portion of the pointer indicator and create one or more 3D depth maps of the at least one remote surface.

22. The method of claim 21, wherein the surface analyzer analyzes the one or more 3D depth maps and constructs a 3D spatial model that represents the at least one remote surface.

23. The method of claim 22, wherein the pointer creates and transmits the data event signal comprising the 3D spatial model to the host appliance.

24. The method of claim 20, wherein the viewing sensor captures one or more light views of an at least a portion of a second pointer indicator from a second spatially aware pointer, the pointer analyzes the one or more light views of the at least a portion of the second pointer indicator and computes an indicator position of the second pointer indicator.

25. The method of claim 22, wherein the pointer creates and transmits the data event signal comprised of the indicator position of the second pointer indicator to the host appliance.

26. The method of claim 20, wherein the housing receives the host appliance.
